(19) United States
(12) Patent Application Publication
(10) Pub. No.: US 2017/0080262 A1
(43) Pub. Date: Mar. 23, 2017

(54) Method And Apparatus For Communication Enhanced Air Filtration Mask

(71) Applicants: Cameron Freres, Oakland, CA (US); Abiu Barocio, Milpitas, CA (US)

(72) Inventors: Cameron Freres, Oakland, CA (US); Abiu Barocio, Milpitas, CA (US)

(73) Assignee: Tech Tools, LLC, Oakland, CA (US)

(21) Appl. No.: 14/858,524

(22) Filed: Sep. 18, 2015

(51) Int. Cl. A62B 9/04; A62B 18/02; A62B 9/00; A62B 23/02; A62B 99/00; H04R 1/02; A62B 18/08

(52) U.S. Cl. CPC A62B 9/04; H04R 1/028; A62B 18/025; A62B 18/084; A62B 23/02; A62B 99/00; A62B 9/006; H04M 9/001

(57) ABSTRACT

The inventive mask solves a major industry problem, which involves the challenge of effectuating clear communications in an environment requiring protective mask use, without the necessity of removing the protective mask. The inventive mask facilitates individual and workplace communications by employing a half-mask or full-mask face protector having a mounting bracket that facilitates incorporation of a basic, intermediate, or advanced level communications module with varying functionality, depending on user preference, workplace requirements, and similar consideration. The inventive mask also incorporates a replaceable selection panel for the communications module, which facilitates access to control mechanisms to enable mask-to-mask, wireless intercom communications and media connection capabilities, and contributes to user cost savings by obviating the prospect of full mask replacement if the replaceable selection panel becomes soiled or otherwise inoperable. The inventive mask also incorporates an intercom module to facilitate communications between inventive mask users and non-users of the inventive mask.

### FIELD OF THE INVENTION

This invention relates to the art and science of air filtration. More specifically, the invention relates to an apparatus and system for providing protective air filtration mask equipment with enhanced voice transmission capabilities for use primarily in potentially hazardous workplace environments.

### BACKGROUND

Epidemiological and related studies over the years have established a demonstrable correlation between the inhalation and deposition of dust in human lungs and the development of a variety of occupational lung disorders. A well-established body of epidemiological and clinical research shows that workers in the so-called dusty trades have an increased prevalence of developing pulmonary and respiratory complications, ranging from shortness of breath, cough and increased sputum to chronic bronchitis, pulmonary airway obstruction, emphysema and cancer.

Although initial observations in this regard were made in coal miners, subsequently similar findings have been observed in steel workers, foundry workers, textile workers, miners, and cement workers. Early studies showed that during the mining of gold, tin, copper, platinum and mica, drilling, crushing and blasting operations at the worksite significantly increased the presence of dust, which correlated to an increased prevalence of respiratory disease in workers.

Asbestos remediation workers, construction site employees, and painters are also among the vast group of individuals who work in proximity to environmental toxins and are often required to wear protective air filtration masks at the workplace in order to avoid toxin exposure and contamination. Workplace toxins can include multiple compounds that, either individually or collectively, pose a significant hazard to workers' respiratory health and wellness. Workplace respiratory hazardous compounds typically include airborne contaminants such as biological contaminants, dusts, mists, fumes, gases or oxygen-deficient atmospheres.

Epidemiological and clinical scientists in the United States and abroad have generated a substantial body of research evaluating occupational exposure to environmental toxins, and differential diagnostic methodologies for identifying corresponding diseases. From asbestos workers, to construction site employees, to paint industry workers, the research clearly links workplace toxin exposure to the development and clinical presentation of a plethora of chronic, and sometimes fatal, pulmonary and respiratory tract diseases.

For instance, research and workplace monitoring—now spanning decades—identify asbestos as a well recognized health hazard. Asbestos is the name for a group of naturally occurring minerals that are resistant to heat and corrosion. The United States Department Of Labor, via the Occupational Safety & Health Administration (OSHA) and the Environmental Protection Agency (EPA) regulate asbestos. Historically, asbestos has been used in various products, including pipe insulation, floor tiles, building materials, and vehicle brakes and clutches. Heavy occupational asbestos exposure typically occurs in the construction industry and ship repair, especially during asbestos remediation or removal resulting from renovation, repairs or demolition. Workers are also exposed during asbestos product manufacturing, including textiles, friction products, insulation and other building materials, and automotive clutch repair work.

Breathing asbestos fibers can cause the development and accumulation of scar-like tissue in the lungs, known as asbestosis, and result in diminished lung function that often progresses to disability and death. Occupational asbestos exposure can also cause lung cancer and mesothelioma, which is a fatal malignant tumor that develops in the lung or stomach lining. According to leading industry commentators, there is no safe asbestos exposure level for any type of asbestos fiber. Workplace asbestos exposures as short in duration as a mere few days has been correlated with causing mesothelioma development in humans. Indeed, every occupational asbestos exposure has the potential to cause disease, and every occupational asbestos exposure can increase the risk of developing an asbestos-related disease. Consequently, where exposure exists, employers are regulated and required to control workplace practices, including by providing employees with protective masks to wear to diminish contact with workplace toxins.

Silicosis is a lung disease caused by inhaling damaging amounts of respirable free crystalline silica. In the construction industry, occupational exposure to crystalline silica is common in several trades due to its presence in a variety of handled materials, including concrete, brick, and mortar. Construction worksite silica exposure is also prevalent due to the way such materials are handled, including breaking, grinding and sawing. Moreover, the construction field is multifaceted, and any one construction site can include multiple trades, tasks, materials and tools that can be linked to crystalline silica exposure.

Reportedly, the most hazardous occupations in construction can be classified into three groups based on exposure levels. Higher exposure level group one includes heavy equipment workers and underground workers such as surveyors, drillers and pipeline laborers. Medium exposure level group two includes cement finishers, bricklayer masons and road milling machine operators. Lower exposure level group three includes tile workers, unskilled laborers, fixed and mobile machine tool operators and other general machine operators. In addition, construction site tasks and tools with the highest possible exposure levels include sawing masonry, bush hammering, masonry breaking, tunnel boring and rock grinding. Consistently wearing properly designed and well-fitted face mask equipment on construction sites is a commonly indicated engineering control implemented to diminish silica exposure.

Painting has been classified as an occupationally related cause of cancer, and the risk of certain cancers is increased in a statistically significant manner by exposures in paint manufacturing processes. Thousands of chemical compounds are used in the paint product manufacturing process, such as pigments, extenders, binders, additives and solvents (i.e., toluene, xylene, ketones, alcohols, esters and glycol ethers). Thus, industry literature reports that occupational exposure to paint may cause an increased risk of several kinds of cancer, including lung, bladder and pancreatic cancer, in addition to lymphatic and hematopoietic tumors. Moreover, dust and fumes from lead-based paints have been shown to cause chromosomal damage resulting in chromosomal aberrations and corresponding disease processes.

Conventional respirators are mask devices commonly employed to protect workers from inhaling potentially dangerous substances, such as chemicals or infectious particulate materials, including those discussed above. Industry commentators report that respirator masks are among the most important pieces of protective equipment for working in hazardous workplace and other contaminated environments. In general, respirator masks work either by filtering particles from the air, chemically purifying the air, or supplying clean air from an external source.

The efficacy of respiratory masks to diminish workplace contaminant exposure is significantly impaired by workers improper use, and in some cases complete nonuse, of such devices in the workplace. If respirator masks are not used properly, or are poorly fitted to the wearer's face, the probability of contaminant exposure increases significantly. For instance, while respirators or other air filtration masks are intended to protect workers from exposure to hazardous materials, such masks cover the wearer's mouth and consequently hamper communication between onsite individuals by deadening or otherwise distorting the wearer's voice. In both documented and undocumented instances, workers in the asbestos, construction, and paint industries, among others, commonly pull down their protective mask equipment onsite at the workplace to talk with each other, which ostensibly defeats the purpose of mask requirements and leaves these individuals at risk for environmental toxin exposure. Frequently, such employees ultimately abandon use of their protective mask equipment altogether after tiring of continually pulling down and subsequently repositioning their masks in order to communicate. Obviously, this problem is not unique to any one industry—respiratory mask abandonment, misuse and displacement due to lack of a sealed fit occur with general contractors, lead abatement workers, painters and others who work near toxins. The improper use, or intermittent non-use, of appropriate protective mask equipment at worksites where environmental toxins exist exposes workers to a plurality of potentially irreversible pulmonary and respiratory tract disorders, as previously discussed and evaluated in industry literature.

Information regarding attempts to address providing effective respirator mask equipment can be found in U.S. Patent Application Publication No. US 2014/0081631 filed by Zhu et al. entitled Wearable Communication System With Noise Cancellation; US Patent Publication No. US 2012/0077438 A1 filed by Jung entitled Bluetooth Headset For Helment Having Inter-Communication Function; U.S. Patent Publication No. US 2014/0216448 filed by Kihlberg entitled Respirator Mask Speech Enhancement Apparatus And Method; European Patent No. KR20130022198 issued to I Tae Jin, et al. for an air breathing mask; European Patent No. KR100801140 issued to Bae Jong Seung entitled Telephone Call Device For Anti-Gas Mask; European Patent No. WO8703154 issued to Goners Shlomo entitled Optical Underwater Communicator; European Patent No. FR2783173 (A1) issues to Le Massons Yves entitled Device For Selectively De-Energizing Communication Equipment Used With Breathing Masks; U.S. Patent Application Publication No. US 2012/0068847 filed by Pirzada entitled System, Device And Process For Remotely Controlling A Medical Device; and U.S. Patent Application Publication No. US 2014/0216447 filed by Kihlberg entitled Respirator Mask Speech Enhancement Apparatus And Method.

However, each one of the previously mentioned references suffers from one or more of several disadvantages. Most notably, the referenced systems, methods and devices lack sufficient capacity to provide a protective respirator mask device that facilitates effective communication among onsite workers while masks remain securely positioned on the face of communicating workers. In addition, the disclosed devices do not incorporate the combined use of noise reduction technology, volume control mechanisms and connection points for accessing smart phones and other electronic devices to communicate with worksite employees while each worker's protective respiratory mask remains fully engaged and secured to the wearer's face.

For the foregoing reasons, a need exists for a method and apparatus to provide protective, worksite respirator mask equipment that allows workers to communicate effectively and comfortably while each worker's protective mask remains securely in place, thereby reducing exposure to environmental workplace toxins.

### SUMMARY

The present invention is directed to a method and apparatus that will satisfy the existing need for a protective respiratory mask that comfortably remains in place on the wearer's face while communicating with others. More specifically, the inventive mask allows onsite workers to communicate with each other, and access external electronic devices, including smart phones and tablets, all while maintaining their respirator masks in a fully engaged, secured position to diminish or eliminate workplace toxin exposure.

The inventive mask comprises a variety of styles, including variations on both half face cartridge masks, and full face positive pressure masks. The inventive mask incorporates conventional electronic components allowing for an internal microphone with a squelch function that connects to a small speaker with a volume adjustment mechanism on the outside of the mask.

It is an object of the present invention to provide a communication enhanced protective mask to facilitate workplace communication, comprising: a face protector having a communication mount to facilitate user communication, a plurality of straps to help secure the mask to a user's face, a plurality of ventilation ports to facilitate respiration with air filtration, and an outer surface and an inner surface to provide a barrier between a mask user's face and airborne workplace contaminants. The inner surface is configured to define a clean air compartment between the inner surface and the user's face to provide filtered, breathable air during use of said mask. The inventive mask further comprises a communication module removeably attached to the face protector communication mount, to facilitate communicate between other similar mask users and non-mask users without removing said mask from the user's face. In addition, the inventive mask comprises a selection panel removeably attached to the communication module to facilitate a user's control of the communication module's functionality during use of the mask without removing the mask from a user's face.

The face protector of the present invention may comprise a half-face mask section having an interior microphone to receive the user's voice, and a plurality of external speakers to broadcast communications. The face protector of the present invention may also comprise a full-face mask section having an interior microphone to receive the user's voice, and a plurality of external speakers to broadcast communications.

The communication mount of the inventive mask comprises a plurality of electrical contacts to facilitate microphone and speaker functionality of the communication module, a rubber bumper to help stabilize the communication module during use of the inventive mask, and a holding latch to facilitate communication module stabilization in connection to the communication mount.

The inventive mask according to the present invention further comprises, in combination, a communication module having a main body and a removeably connected selection panel, wherein said main body comprises a plurality of electrical contacts to connect to the communication mount of the face protector to facilitate information transmission to the communication module main body, a USB jack, and a plurality of electrical contacts to connect to the selection panel. The selection panel comprises a plurality of LED indicator lights to display device status, a plurality of electrical contacts to facilitate information communication to the communication module main body, a jog dial to facilitate controlling communication module power, volume, squelch and multiple other device functions, and a speaker button to facilitate speaker activation.

The inventive mask according to the present invention further comprises, in combination, a communication module having a main body and a removeably connected selection panel, wherein said main body comprises a plurality of electrical contacts to connect to said communication mount of said face protector to facilitate information transmission to the communication module main body, a USB jack, a headphone jack, and a plurality of electrical contacts to connect to the selection panel, which comprises a plurality of LED indicator lights to display device status, a plurality of electrical contacts to facilitate information communication to the communication module main body, a jog dial to facilitate controlling communication module power, volume, squelch and multiple other device functions, a speaker button to facilitate speaker activation, and an intercom button to facilitate intercom activation.

According to the present invention, the inventive mask further comprises, in combination, a communication module having a main body and a removeably connected selection panel, wherein the main body comprises a plurality of electrical contacts to connect to the communication mount of the face protector to facilitate information transmission to the communication module main body, a USB jack, a headphone jack, an AUX jack to facilitate connection to external media and telephone devices, and a plurality of electrical contacts to connect to the selection panel, which comprises a plurality of LED indicator lights to display device status, a plurality of electrical contacts to facilitate information communication to the communication module main body, a jog dial to facilitate controlling communication module power, volume, squelch and multiple other device functions, a speaker button to facilitate speaker activation, an intercom button to facilitate intercom activation, and a media button to facilitate external media activation.

The invention further comprises a communication module comprising, alternatively, a handheld device having a microphone to facilitate intercom transmission, at least one speaker to broadcast intercom transmissions, a plurality of indicator LEDs to display device status, a plurality of control buttons to facilitate control of device power, volume and intercom activation, a USB jack and a headphone jack.

It is a further object of the present invention to provide a speech enhanced protective mask to facilitate workplace communication comprising, in combination: a face protector comprising a communication mount to facilitate user communication, a plurality of externally disposed straps to help secure the mask to a user's face, a plurality of ventilation ports to facilitate respiration with air filtration, and an outer surface and an inner surface configured to define a clean air space between the inner surface and a user's face to provide filtered, breathable air during use of the mask; a communication module removeably attached to the communication mount of said face protector to facilitate communication between mask users and non-mask users without removing the mask from the user's face. The communication module comprises a main body having a plurality of electrical contacts to facilitate communication, and a USB jack to supply power to recharge batteries and allow external software access. The inventive mask further comprises a selection panel removeably attached to the communication module to facilitate a user's control of the communication module functionality, wherein the selection panel comprises a plurality of LED indicator lights to display device status, a plurality of electrical contacts to facilitate information communication to the communication main body, a jog dial to facilitate controlling communication module power, volume, squelch and multiple other device functions, and a speaker button to facilitate speaker activation.

According to the present invention, the communication module main body further comprises a plurality of rubber gaskets to protect the plurality of electrical contacts from debris, moisture and other external contaminants, and a holding latch to help stabilize the communication module in relation to the communication mount. The communication module comprises, alternatively, a handheld device having a microphone to facilitate intercom transmission, at least one speaker to broadcast intercom transmissions, a plurality of indicator LEDs to display device status, a plurality of control buttons to facilitate control of device power, volume and intercom activation, a USB jack and a headphone jack.

According to the present invention, the face protector comprises a half-face mask section having an interior microphone to receive the user's voice, and a plurality of external speakers to broadcast communications. The inventive mask also comprises a face protector having a full-face mask section having an interior microphone to receive the user's voice, and a plurality of external speakers to broadcast communications.

It is yet a further object of the present invention to provide a speech enhanced protective mask to facilitate workplace communication, comprising in combination: a face protector comprising a communication mount to facilitate user communication, a plurality of externally disposed straps to help secure the mask to a user's face, a plurality of ventilation ports to facilitate respiration with air filtration, and an outer surface and an inner surface configured to define a clean air space between the inner surface and a user's face to provide filtered, breathable air during use of said mask; a communication module removeably attached to the communication mount of the face protector to facilitate communication between mask users and non-mask users without removing the mask from the user's face. The communication module comprises a main body having a plurality of electrical contacts to facilitate communication, a USB jack to supply power to recharge batteries and allow external software access, and a headphone jack. The inventive speech enhances protective mask further comprises a selection panel removeably attached to the communication module to facilitate a user's control of the communication module functionality. The selection panel comprises a plurality of LED indicator lights to display device status, a plurality of electrical contacts to facilitate information communication to the communication main body, a jog dial to facilitate controlling communication module power, volume, squelch and multiple other device functions, a speaker button to facilitate speaker activation and an intercom button to control intercom activation.

According to the present invention, the communication module main body further comprises a plurality of rubber gaskets to protect the plurality of electrical contacts from debris, moisture and other external contaminants, and a holding latch to help stabilize the communication module in relation to the communication mount; and wherein the selection panel further comprises a plurality of positioning tabs and screws to stabilize the selection panel to the communication module main body. The communication module comprises, alternatively, a handheld device having a microphone to facilitate intercom transmission, at least one speaker to broadcast intercom transmissions, a plurality of indicator LEDs to display device status, a plurality of control buttons to facilitate control of device power, volume and intercom activation, a USB jack and a headphone jack. The face protector comprises a half-face mask section having an interior microphone to receive the user's voice, and a plurality of external speakers to broadcast communications. The face protector comprises a full-face mask section having an interior microphone to receive the user's voice, and a plurality of external speakers to broadcast communications.

It is yet a further object of the present invention to provide a speech enhanced protective mask to facilitate workplace communication comprising, in combination; a face protector comprising a communication mount to facilitate user communication, a plurality of externally disposed straps to help secure the mask to a user's face, a plurality of ventilation ports to facilitate respiration with air filtration, and an outer surface and an inner surface configured to define a clean air space between the inner surface and a user's face to provide filtered, breathable air during use of the mask. The invention further comprises, in combination, a communication module removeably attached to the communication mount of the face protector to facilitate communication between mask users and non-mask users without removing the mask from the user's face, wherein the communication module comprises a main body having a plurality of electrical contacts to facilitate communication, a USB jack to supply power to recharge batteries and allow external software access, a headphone jack, and an AUX jack. The invention further comprise a selection panel removeably attached to the communication module to facilitate a user's control of the communication module functionality, wherein the selection panel comprises a plurality of LED indicator lights to display device status, a plurality of electrical contacts to facilitate information communication to the communication main body, a jog dial to facilitate controlling communication module power volume, squelch and multiple other device functions, a speaker button to facilitate speaker activation, an intercom button to control intercom activation, and a media button to control media activation.

The communication module main body further comprises a plurality of rubber gaskets to protect the plurality of electrical contacts from debris, moisture and other external contaminants, and a holding latch to help stabilize the communication module in relation to the communication mount; and wherein the selection panel further comprises a plurality of positioning tabs and screws to stabilize the selection panel to the communication module main body. The communication module comprises, alternatively, a handheld device having a microphone to facilitate intercom transmission, at least one speaker to broadcast intercom transmissions, a plurality of indicator LEDs to display device status, a plurality of control buttons to facilitate control of device power, volume and intercom activation, a USB jack and a headphone jack. The face protector comprises a half-face mask section having an interior microphone to receive the user's voice, and a plurality of external speakers to broadcast communications. The face protector further comprises a full-face mask section having an interior microphone to receive the user's voice, and a plurality of external speakers to broadcast communications.

The inventive mask of the present invention provides several advantages. The inventive mask is fabricated to accommodate individual user choice, and can be used in a variety of workplace conditions. For instance, the inventive mask comprises a half-mask and a full-mask face protector, which may be selected based on an individual user's choice, and to accommodate specific workplace environments. The inventive communications modules offer a variety of technological and functional user options, which a user may deploy depending on individual preference, or workplace condition requirements. For instance, the use of an inventive communication mask having basic, intermediate or advanced functional capabilities is made possible by giving users the option to select a basic, intermediate or advanced communications module according to the present invention. Moreover, the present invention provides the added option of employing a handheld intercom device, which a non-inventive mask user may use to communicate with individuals wearing the inventive mask.

Significantly, the inventive mask solves a major problem in the industry, which involves the challenge of effectuating clear communications in an environment requiring protective mask use, without the necessity of removing the protective mask. Removing a protective mask to speak with a co-worker, answer a cell phone call, listen to music on an external device, or otherwise facilitate communications with others, obviates the protective aspects of such a mask, and puts the mask user in harm's way. The inventive protective mask is fabricated to allow its users to engage such communications, and more, without removing the inventive protective mask in order to achieve communications.

Because the inventive mask comprises a selection panel that allows a user to control access to, and adjustment of, multiple aspects of mask-to-mask or intercom communications, a user of the inventive mask need not remove the mask to communicate with others. Rather, a user need only adjust the easily accessible selection panel in order to initiate, receive and complete a variety of external communications—without the necessity of removing the protective mask. Thus, the inventive device provides clear communications functionality combined with protective air filtration, respiratory support functionality, and other advantageous aspects of wearing a protective mask to avoid exposure to airborne contaminants, environmental hazards, chemical toxins, and other such airborne contaminants. Because a user may adjust the selection panel frequently, and thereby soil or otherwise damage the selection panel, the invention discloses a replaceable selection panel, which may be interchanged with a damaged or dysfunctional selection panel, adding costs savings in addition to broad functionality and respiratory protection.

These and other features, aspects, and advantages of the present invention will become better understood with regard to the following drawings, descriptions and appended claims.

### BRIEF DESCRIPTION OF THE DRAWINGS

FIG. 1A is a side view of a half-mask face protector with a communications module attached according to the present invention.

FIG. 1B is a front view of a half-mask face protector with a communications module attached according to the present invention.

FIG. 2A is a side view of a full-mask face protector with a communications module attached according to the present invention.

FIG. 2B is a front view of a full-mask face protector with a communications module attached according to the present invention.

FIG. 3 is a side view of a half-mask face protector without a communications module attached according to the present invention.

FIG. 4 is front view of a half-mask face protector without a communications module attached according to the present invention.

FIG. 5 is a bottom view of a half-mask face protector without a communications module attached according to the present invention.

FIG. 6 is a side view of a full-mask face protector without a communications module attached according to the present invention.

FIG. 7 is a front view of a full-mask face protector without a communications module attached according to the present invention.

FIG. 8 is a bottom view of a full-mask face protector without a communications module attached according to the present invention.

FIG. 9 is a side view of a basic communications module with a replaceable basic selection panel attached according to the present invention.

FIG. 10 is a front view of a basic communications module with a replaceable basic selection panel attached according to the present invention.

FIG. 11 is a top view of a basic communications module with a replaceable basic selection panel attached according to the present invention.

FIG. 12 is a side view of a basic communications module without a replaceable basic selection panel attached according to the present invention.

FIG. 13 is a front view of a basic communications module without a replaceable basic selection panel attached according to the present invention.

FIG. 14 is a top view of a basic communications module without a replaceable basic selection panel attached according to the present invention.

FIG. 15 is a side view of a replaceable basic selection panel according to the present invention.

FIG. 16 is a front view of a replaceable basic selection panel according to the present invention.

FIG. 17 is a top view of a replaceable basic selection panel according to the present invention.

FIG. 18 is a side view of an intermediate communications module with a replaceable intermediate selection panel attached according to the present invention.

FIG. 19 is a front view of an intermediate communications module with a replaceable intermediate selection panel attached according to the present invention.

FIG. 20 is top view of an intermediate communications module with a replaceable intermediate selection panel attached according to the present invention.

FIG. 21 is a side view of an intermediate communications module without a replaceable intermediate selection panel attached according to the present invention.

FIG. 22 is a front view of an intermediate communications module without a replaceable intermediate selection panel attached according to the present invention.

FIG. 23 is a top view of an intermediate communications module without a replaceable intermediate selection panel attached according to the present invention.

FIG. 24 is a side view of a replaceable intermediate selection panel according to the present invention.

FIG. 25 is a front view of a replaceable intermediate selection panel according to the present invention.

FIG. 26 is a top view of a replaceable intermediate selection panel according to the present invention.

FIG. 27 is a side view of an advanced communications module with a replaceable advanced selection panel attached according to the present invention.

FIG. 28 is a front view of an advanced communications module with a replaceable advanced selection panel attached according to the present invention.

FIG. 29 is a top view of an advanced communications module with a replaceable advanced selection panel attached according to the present invention.

FIG. 30 is a side view of an advanced communications module without a replaceable advanced selection panel attached according to the present invention.

FIG. 31 is a front view of an advanced communications module without a replaceable advanced selection panel attached according to the present invention.

FIG. 32 is a top view of an advanced communications module without a replaceable advanced selection panel attached according to the present invention.

FIG. 33 is a side view of a replaceable advanced selection panel according to the present invention.

FIG. 34 is a front view of a replaceable advanced selection panel according to the present invention.

FIG. 35 is a top view of a replaceable advanced selection panel according to the present invention.

FIG. 36 is a front view of a handheld communications module according to the present invention.

FIG. 37 is a bottom view of a handheld communications module according to the present invention.

FIG. 38 is a block diagram illustrating the internal functionality of a basic communications module with face protector according to the present invention.

FIG. 39 is a block diagram illustrating the internal functionality of an intermediate communications module with a face protector according to the present invention.

FIG. 40 is a block diagram illustrating the internal functionality of an advanced communications module with a face protector according to the present invention.

FIG. 41 is a block diagram illustrating the internal functionality of a handheld communications module according to the present invention.

### DETAILED DESCRIPTION OF PREFERRED EMBODIMENTS

Inventive mask (10) is fabricated to facilitate communication during use, without the necessity of mask removal, to achieve clear communication and simultaneously diminish or eliminate a user's exposure to workplace and environmental airborne contaminants. Generally, inventive mask (10) comprises an integrated interchangeable face protector, an interchangeable communications module (which allows users to choose the level and extent of mask (10) functionality based on individual preference), and a replaceable selection panel, which allows users to replace the selection panel should the corresponding button(s) or dial become damaged in harsh conditions.

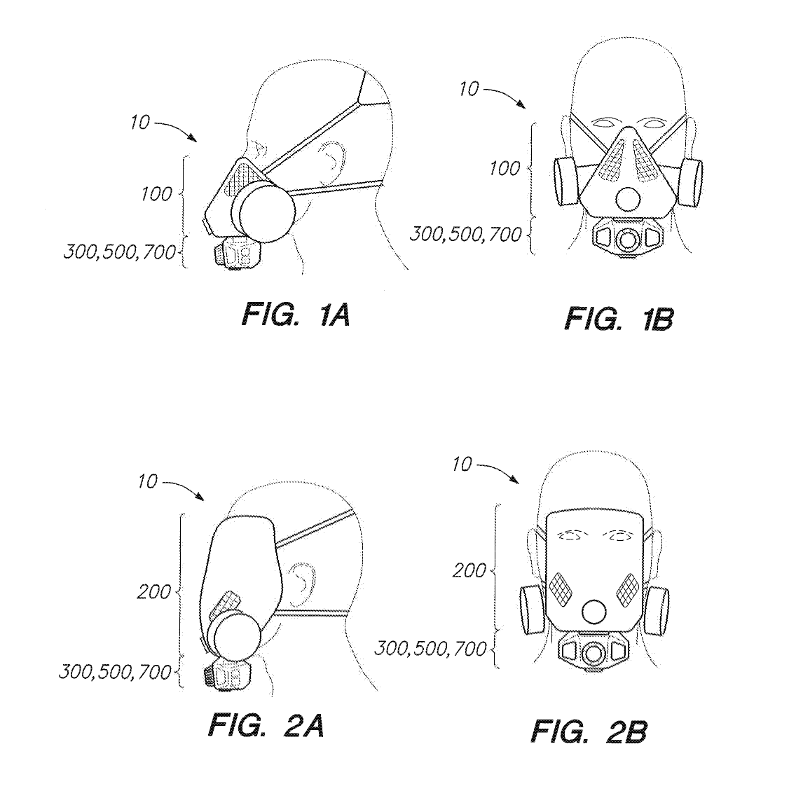

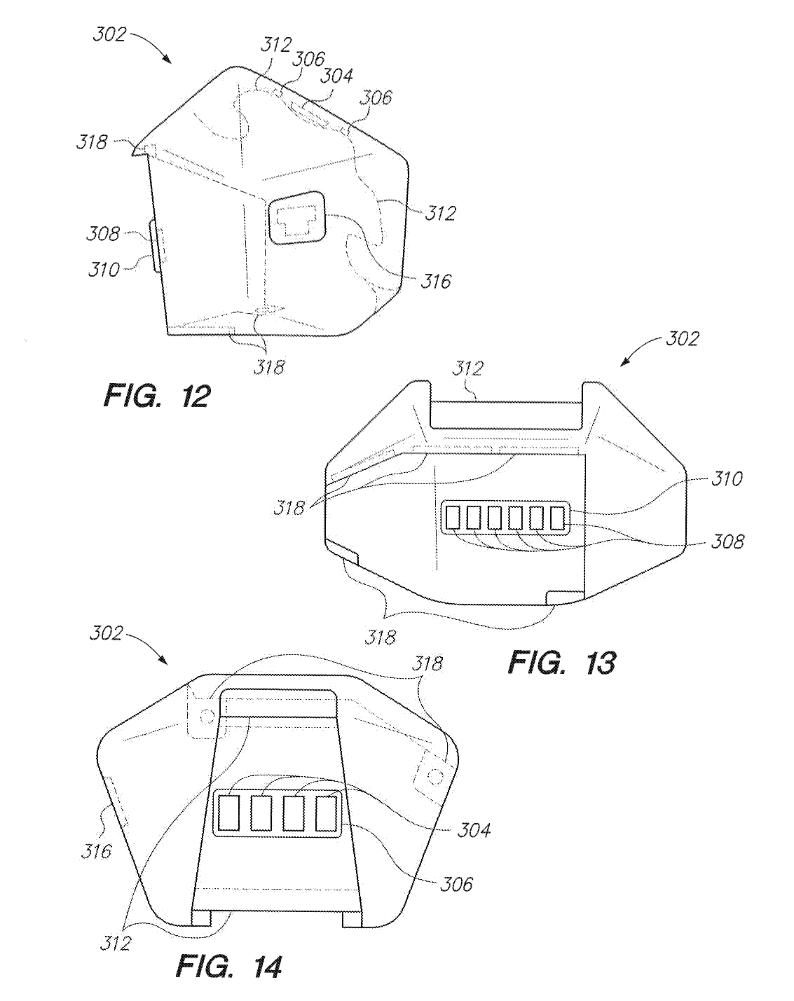

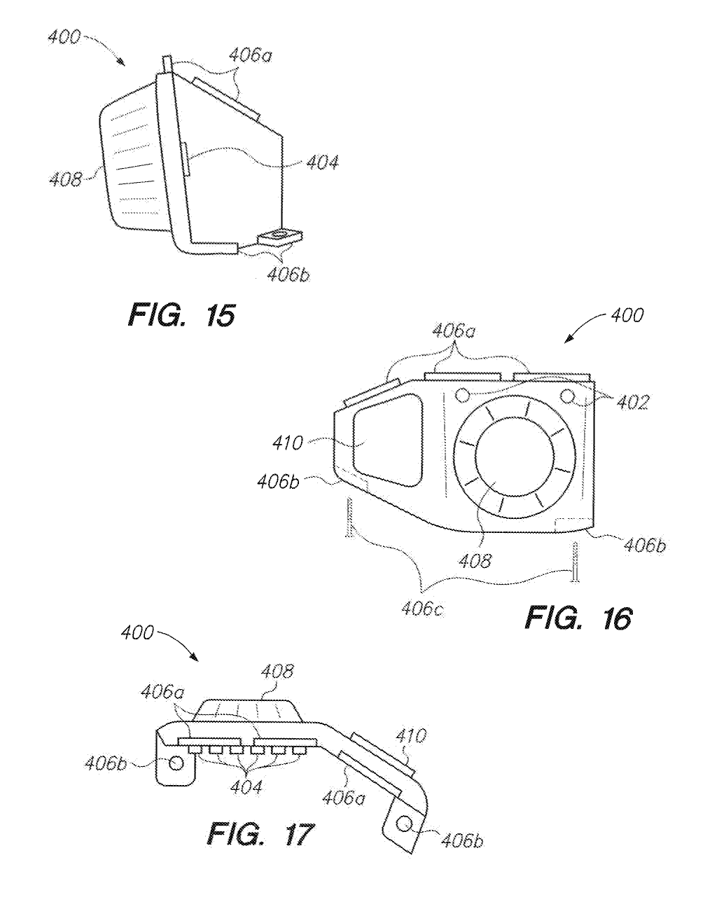

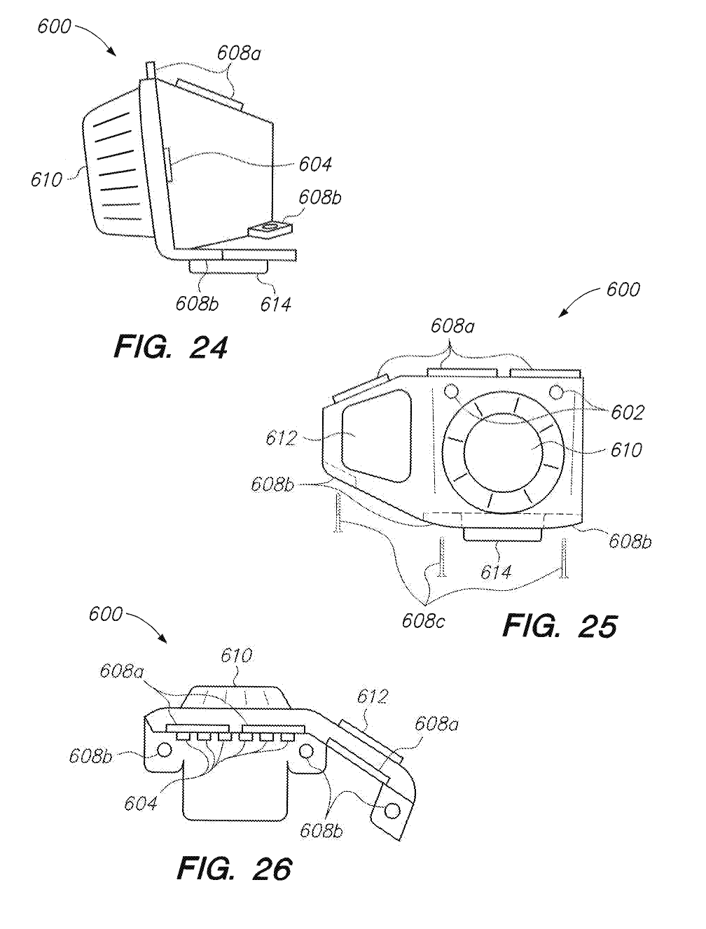

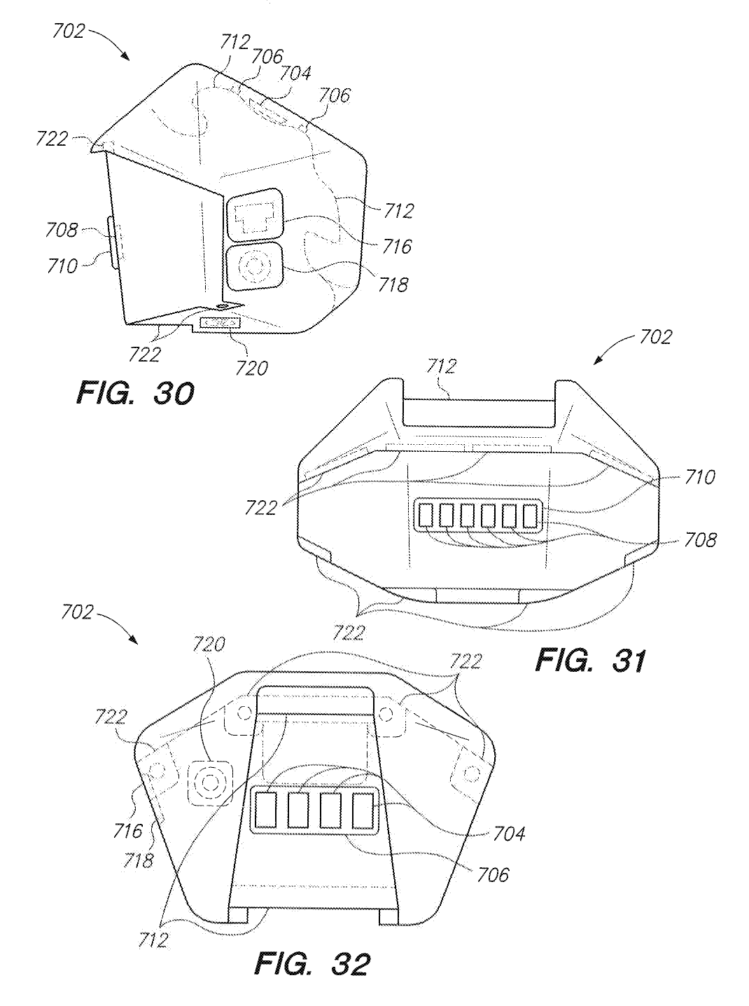

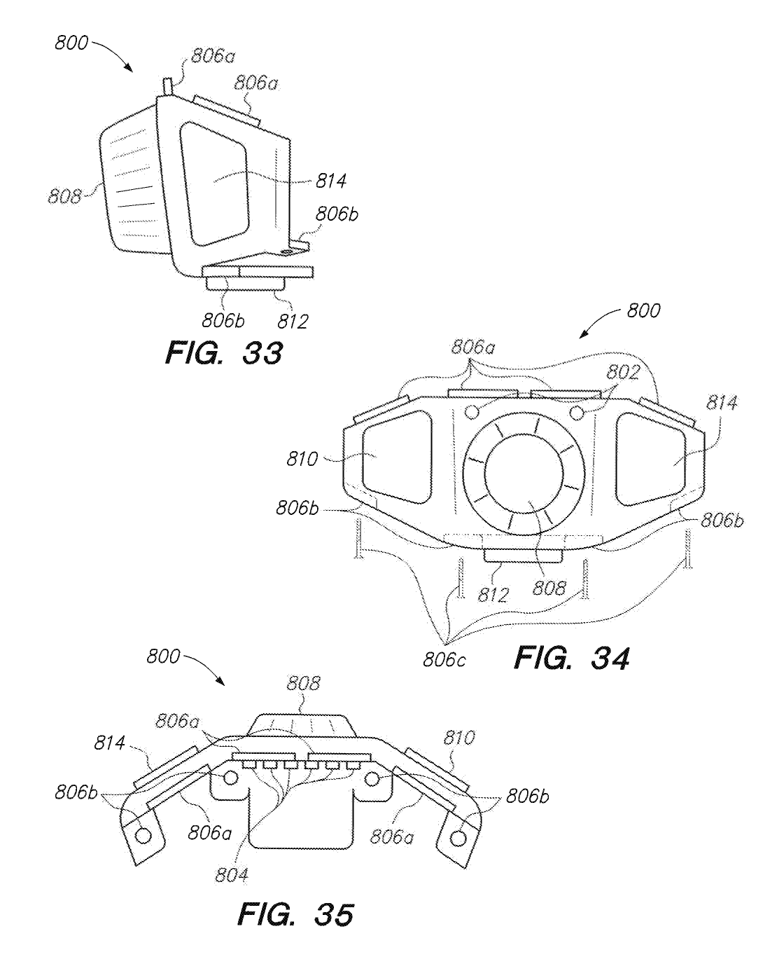

As detailed below, mask (10) may comprise either a half-mask face protector (100) (FIGS. 1A, 1B), or a full-mask face protector (200) (FIGS. 2A, 2B). Depending on user preference, mask (10) may further comprise a basic communications module (300) (FIGS. 12-14), an intermediate communications module (500) (FIGS. 21-23) or an advanced communications module (700) (FIGS. 30-32). Again, depending on user preference of module, mask (10) may comprise a replaceable basic selection panel (400) (FIGS. 15-17), a replaceable intermediate selection panel (600) (FIGS. 24-26), or a replaceable advanced selection panel (800) (FIGS. 33-35). As more fully explained below, basic, intermediate and advanced components of mask (10) comprise varying levels of functionality, giving users a choice regarding structural and technological mask preferences.

### Half-Mask Face Protector (100)

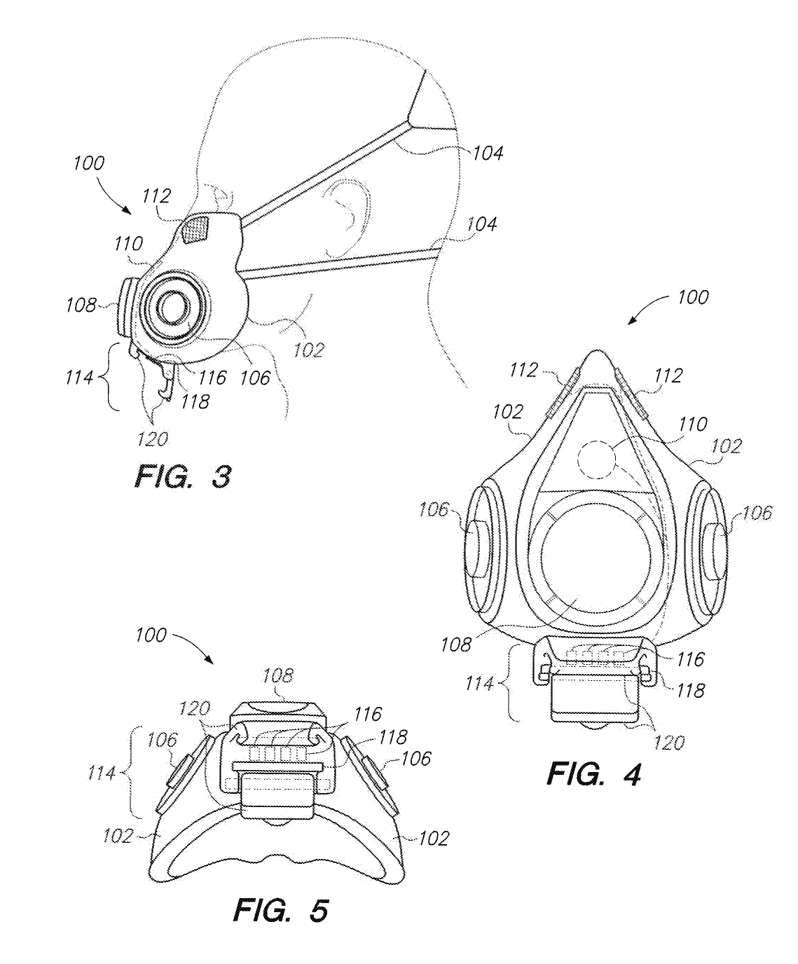

As depicted in FIGS. 3, 4 and 5, half-mask face protector (100) comprises a plurality of plastic or rubber gaskets (102) to seal off interior airspace from exterior pollutants, a plurality of straps (104) to secure mask (10) against a user's face and head, and a plurality of air intake ports (106) where conventional replaceable air filtration media attaches to filter incoming air and thereby facilitate breathing during use of inventive mask (10). Face protector (100) further comprises exhalation ports (108), which allows carbon dioxide and humidity to exit mask (10) during use, an interior microphone (110) to record and transmit a user's voice, and at least one exterior speaker (112) to broadcast a user's voice or broadcast intercom or media transmissions.

Face protector (100) further comprises communications module mount (114), which is fabricated to connect to basic communications module (300), intermediate communications module (500) or advanced communications module (700) (as described below), depending on user preference. Communications module mount (114) comprises a plurality of electrical contacts (116) to facilitate microphone (110) and exterior speaker (112) functionality in relation to basic communications module (300), intermediate communications module (500) or advanced communication module (700), depending on user preference, as more fully set forth below. Communications module mount (114) further comprises male section holding latch (120), which facilitates securing basic communications module (300), intermediate communications module (500), or advanced communications module (700) in place against communications module mount (114). Communications module mount (114) further comprises rubber bumper (118) to help apply pressure against holding latch (120) to maintain basic communications module (300), intermediate communications module (500) or advanced communications module (700) in place during use of mask (10).

### Full-Mask Face Protector (200)

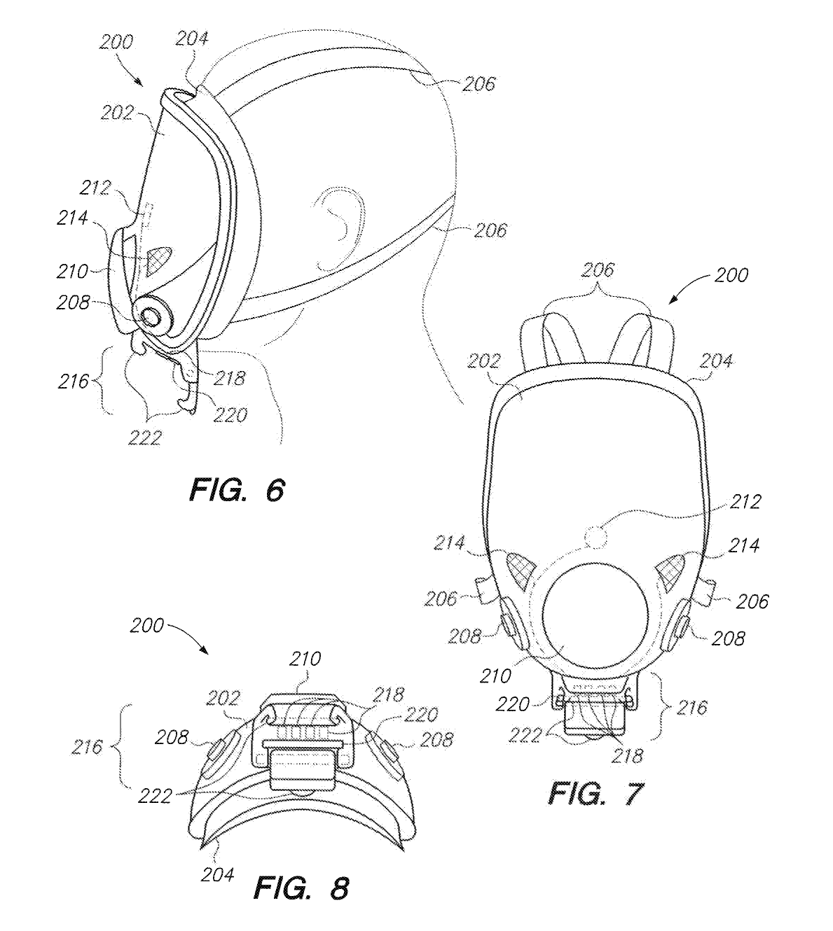

As depicted in FIGS. 6, 7, and 8, full-mask protector (200) comprises clear plastic viewport (202) and rubber or plastic gasket (204) to seal off interior space from exterior airborne contaminants. Face protector (200) further comprises a plurality of air intake ports (208) to which conventional replaceable air filtration media attach to facilitate incoming air filtration, at least one exhalation port (210) to allow carbon dioxide and humidity to exit mask (10), and a plurality of straps (206) to hold mask (10) against a user's face and head. Face protector (200) further comprises interior microphone (212) to record and transmit a user's voice during use of mask (10), and at least one external speaker (214) to broadcast a user's voice or broadcast intercom and media transmissions during use of mask (10).

Face protector (200) further comprises communications module mount (216), which is fabricated to connect to basic communications module (300), intermediate communications module (500) or advanced communications module (700) depending on user preference, as more fully set forth below. Communications module mount (216) comprises a plurality of electrical contacts (218) to facilitate microphone (212) and exterior speaker (214) functionality in relation to basic communications module (300), intermediate communications module (500) or advanced communications module (700), depending on user preference, as more fully set forth below. Communications module mount (216) further comprises male section holding latch (222), which facilitates securing basic communications module mount (300), intermediate communications mount (500) or advanced communications module (700) in place against communications module mount (216). Communications module mount (216) further comprises rubber bumper (220) to help apply pressure against holding latch (222) to maintain basic communications module (300), intermediate communications module (500) or advanced communications module (700) in place during use of mask (10).

### Basic Communications Module (300)

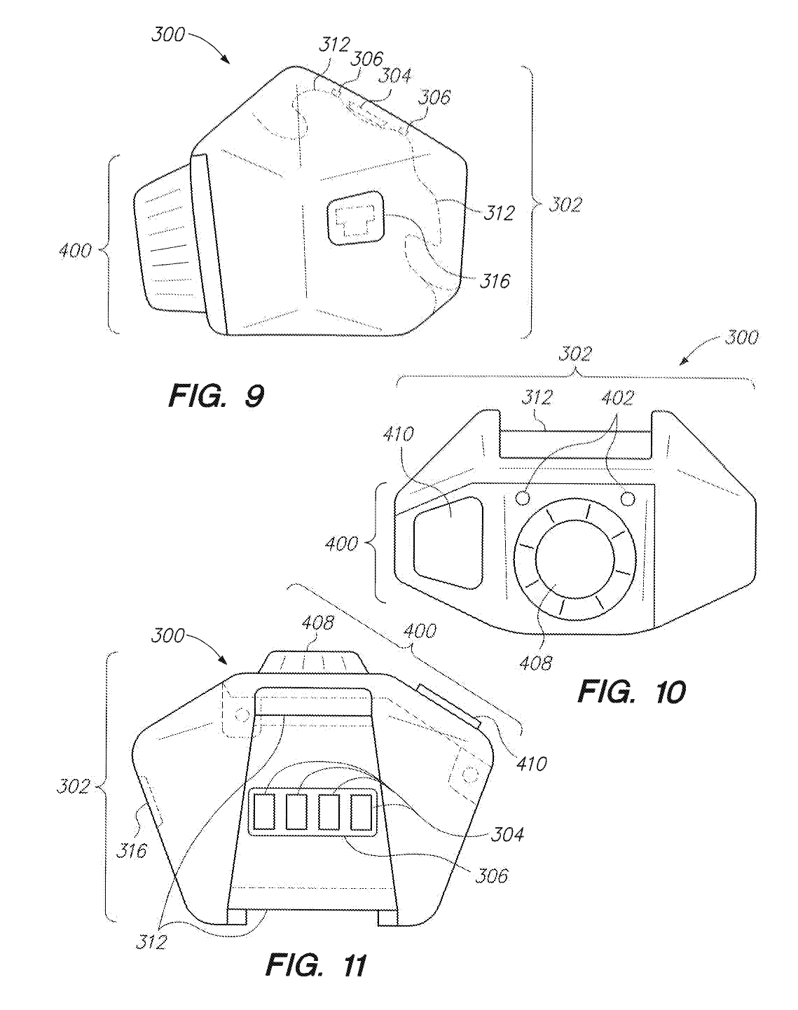

As depicted in FIGS. 9-11, basic communications module (300) comprises basic communications module main body (302) having a replaceable basic selection panel (400), which facilitates access to a plurality of functional options during use of mask (10). Basic communications module main body (302) further comprises a plurality of electrical contacts (304) to mate with communications module mount (114) of half-mask face protector (100) (FIGS. 3-5) or communications module mount (216) of full-mask face protector (200) (FIGS. 6-8), which facilitates transmitting basic communications module (300) functions to mask (10). Basic communications module main body (302) further comprises rubber gasket (306) for communications module mount (114) of half-mask face protector (100), or for communications module mount (216) of full-mask face protector (200). Gasket (306) is fabricated to protect electrical connections from debris and moisture, particularly electrical connections between basic communications module (300) and communications module mount (114) of half-mask face protector (100), and electrical connections between basic communications module (300) and communications module mount (216) of full-mask face protector (200).

As depicted in FIGS. 9-14, basic communications module main body (302) further comprises a plurality of electrical contacts (308) (FIGS. 12-13) to mate with replaceable basic selection panel (400), which allows replaceable basic selection panel (400) functional options to be transmitted to basic communications module main body (302). Basic communications module main body (302) further comprises rubber gasket (310) (FIGS. 12-13) to protect electrical connections between basic communications module main body (302) and replaceable basic selection panel (400) from debris and moisture.

Basic communications module main body (302) further comprises female section holding latch (312) (FIGS. 9-14) to mate with and hold basic communications module (300) in place against communications module mount (114) of half-mask face protector (100) or communications module mount (216) of full-mask face protector (200). Basic communications module main body (302) is fabricated having USB jack (316) to facilitate battery charging and firmware updates to basic communications module (300). The USB jack (316) is protected by a rubber or plastic flap or plug to protect it from harsh environments when mask (10) is in use.

FIGS. 9-11 and FIGS. 15-17 depict replaceable basic selection panel (400), which allows mask (10) users to select various functions available using communications module (300). Basic selection panel (400) comprises a plurality of indicator light-emitting diode devices (402) (FIGS. 10, 16) to display mask (10) status, and a plurality of electrical contacts (404) (FIGS. 15, 17) to allow replaceable basic selection panel (400) options to be transmitted to basic communications module main body (302). Replaceable basic selection panel (400) further comprises a plurality of male tabs (406a) and plurality of screw-hole male tabs (406b) and securing screws (406c) (FIGS. 15-17) to mate with female tab-spaces (318) (FIGS. 12-14) to stabilize replaceable basic selection panel (400) in relation to basic communications module main body (302). Replaceable basic selection panel (400) further comprises jog dial (408) (FIGS. 9-11 and FIGS. 15-17) to facilitate access to a plurality of functionality options, comprising volume, squelch sensitivity, noise reduction levels and similar adjustable functions. Speaker button (410) (FIGS. 10, 11 and FIGS. 16, 17) located on replaceable basic selection panel (400) facilitates speaker activation when basic communications module (300) is in use.

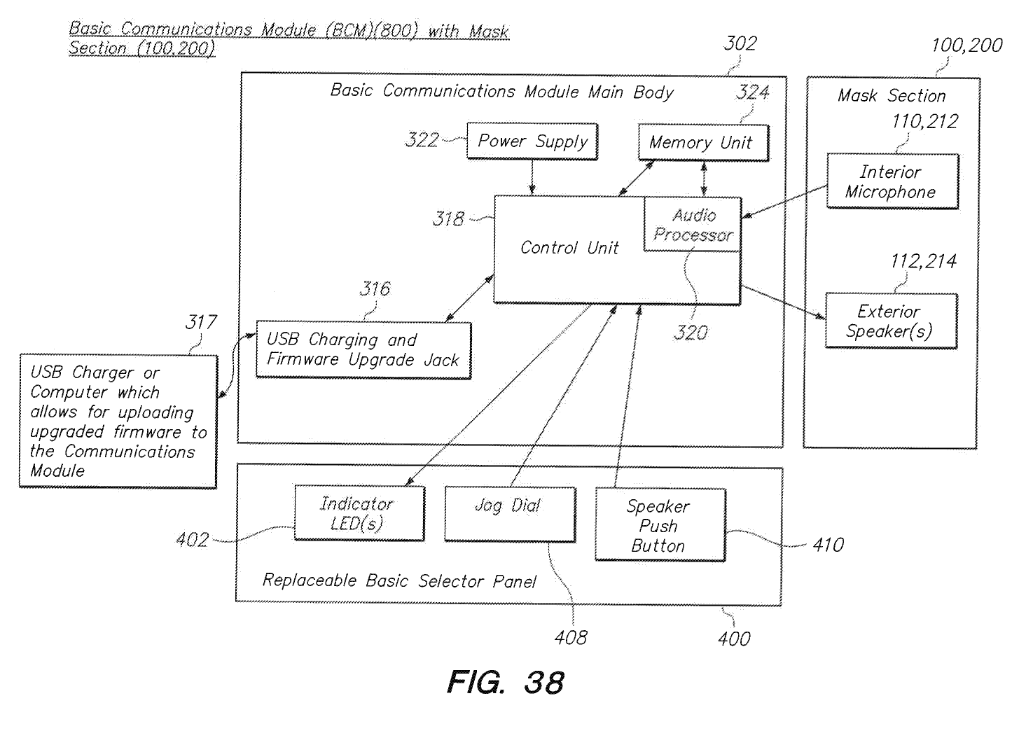

As diagrammed in FIG. 38, basic communications module main body (302) further comprises power supply (322), memory unit (324), and control unit (318) having an internally disposed audio processor (320). An external USB charger (317) may be connected to the USB jack (316) using conventional wire technologies to facilitate charging of internal power supply (322) of basic communications module (300). Alternatively, a computer system (317) may be connected to USB jack (316) using conventional wire technologies to facilitate transmitting firmware upgrades to control unit (318) or audio processor (320), and to facilitate charging internal power supply (322) of the basic communications module (300).

### Intermediate Communications Module (500)

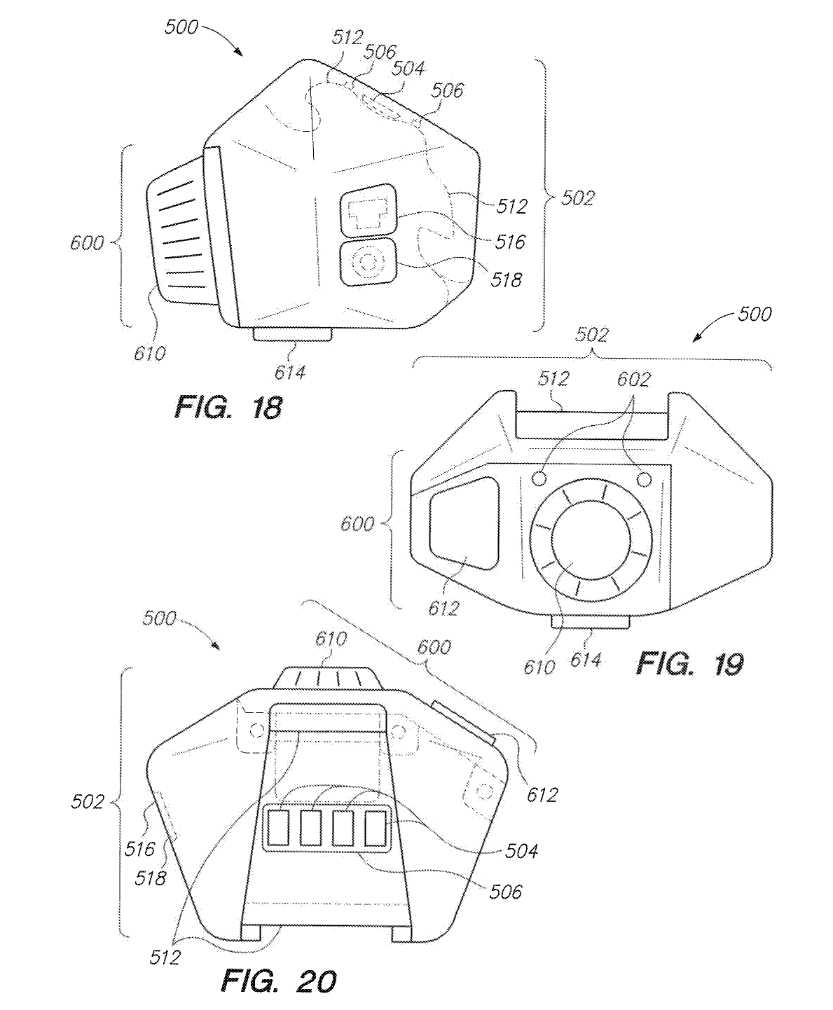

As depicted in FIGS. 18-23, intermediate communications module (500) comprises intermediate communications module main body (502) having a replaceable intermediate selection panel (600), which facilitates access to a plurality of functional options available during use of mask (10). Intermediate communications module main body (502) comprises a plurality of electrical contacts (504) to mate with communications module mount (114) of half-mask face protector (100) (FIGS. 3-5) or communications module mount (216) of full-mask face protector (200) (FIGS. 6-8), which facilitates transmitting intermediate communications module (500) functions to mask (10). Intermediate communications module main body (502) further comprises rubber gasket (506) (FIGS. 18, 20, 21, 23) for communications module mount (114) of half-mask face protector (100) (FIGS. 3-5), or for communications module mount (216) of full-mask face protector (200) (FIGS. 6-8). Gasket (506) is fabricated to protect, from debris and moisture, electrical connections between intermediate communications module (500) and communications module mount (114) of half-mask face protector (100), or communications module mount (216) of full-mask face protector (200).

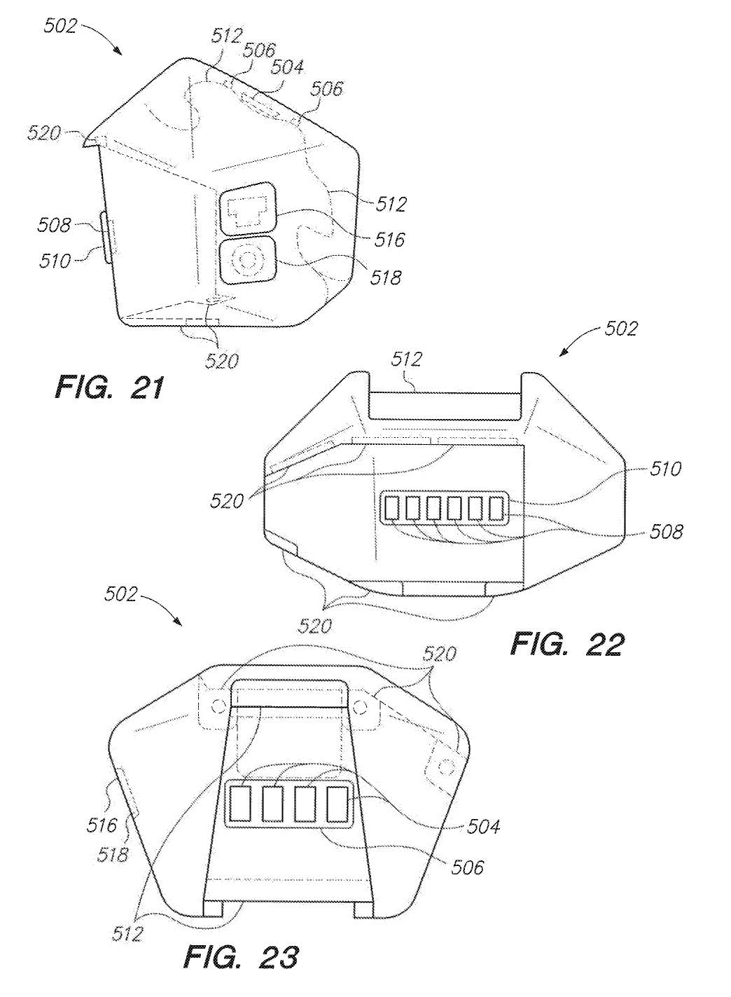

Communications module main body (502) further comprises a plurality of electrical contacts (508) (FIGS. 21, 22) to mate with replaceable intermediate selection panel (600), which allows replaceable intermediate selection panel (600) functional options to be transmitted to intermediate communications module main body (502).

Intermediate communications module main body (502) further comprises rubber gasket (510) (FIGS. 21, 22) for replaceable intermediate selection panel (600), set forth below, to protect electrical connections between intermediate communications module main body (502) and replaceable intermediate selection panel (600) from debris and moisture. Intermediate communications module main body (502) further comprises female section holding latch (512) to mate with and secure intermediate communications module (500) in place against communications module mount (114) of half-mask face protector (100) (FIGS. 3-5) or communications module mount (216) of full-mask face protector (200) (FIGS. 6-8). Intermediate communications module main body (502) is fabricated having USB jack (516) (FIGS. 18, 20, 21, 23) to facilitate battery charging and firmware updates. The USB jack (516) is protected by a rubber or plastic flap or plug to protect it from harsh environments when mask (10) is in use. Intermediate communications module main body (502) is fabricated having a standard 3.5 mm headphone jack (518) (FIGS. 18, 20, 21, 23) to facilitate privacy by broadcasting intercom transmissions through externally connected headphones. The standard 3.5 mm headphone jack (518) is protected by a rubber or plastic flap or plug to protect it from harsh environments when mask (10) is in use.

FIGS. 18-20 and FIGS. 24-26 depict replaceable intermediate selection panel (600), which allows mask (10) users to select various functions available with intermediate communications module (500) during use of mask (10). Replaceable intermediate selection panel (600) comprises a plurality of indicator light-emitting diode devices (602) (FIGS. 19, 25) to display mask (10) status during use, and a plurality of electrical contacts (604) (FIGS. 24, 26) to allow replaceable intermediate selection panel (600) options to be transmitted to intermediate communications module main body (502). Replaceable intermediate selection panel (600) further comprises a plurality of male tabs (608a) and plurality of screw-hole male tabs (608b) (FIGS. 24-26) and securing screws (608c) to mate with female tab-spaces (520) (FIGS. 21-23) to stabilize replaceable intermediate selection panel (600) in relation to intermediate communications module main body (502). Replaceable intermediate selection panel (600) further comprises jog dial (610) (FIGS. 18-20 and FIGS. 24-26) to access a plurality of functionality options, comprising volume, squelch sensitivity, noise reduction levels and similar adjustable functions as more fully discussed below. Speaker button (612) (FIGS. 19, 20 and FIGS. 25, 26) located on replaceable intermediate selection panel (600) facilitates speaker activation when intermediate communications module (500) is in use. Replaceable intermediate selection panel (600) further comprises intercom button (614) (FIGS. 18, 19, 24), which facilitates intercom activation when mask (10) is in use.

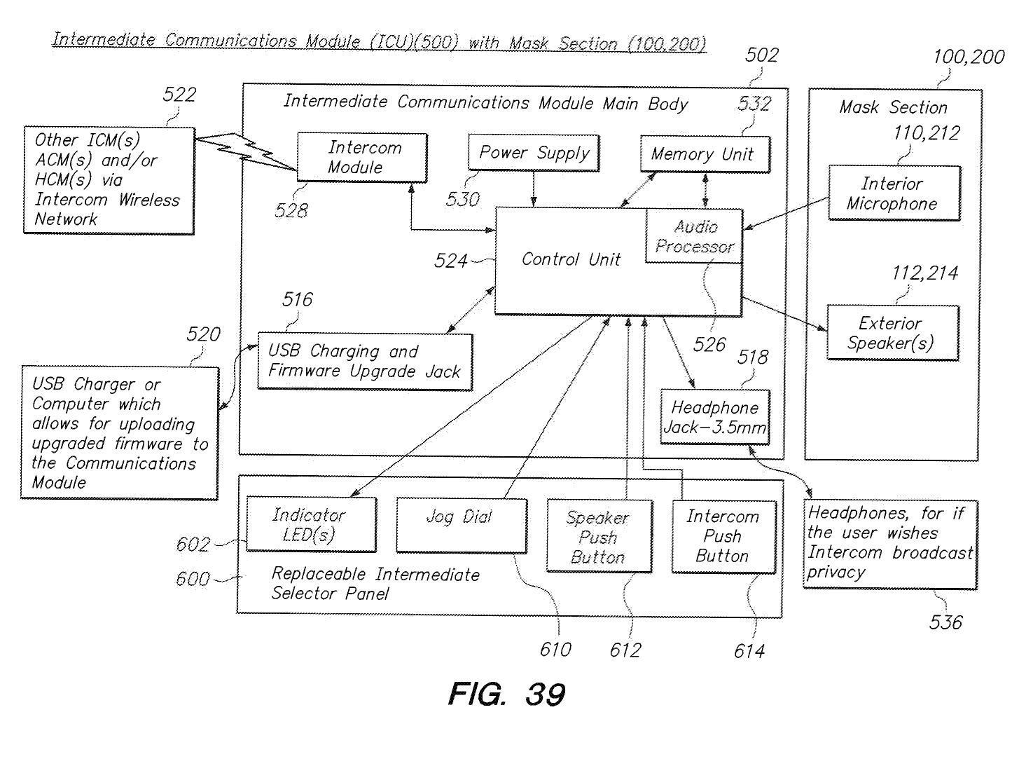

As diagrammed in FIG. 39, intermediate communications module main body (502) further comprises wireless intercom module (528), power supply (530), memory unit (532), and control unit (524) having an internally disposed audio processor (526). An external USB charger (520) may be connected to the USB jack (516) using conventional wire technologies to facilitate charging of the internal power supply (530) of the intermediate communications module (500). Alternatively, a computer system (520) may be connected to USB jack (516) using conventional wire technologies to facilitate transmitting firmware upgrades to control unit (524) or audio processor (526) as well as charging of the internal power supply (530) of the intermediate communications module (500). The intercom module of another similar device user's unit (522) may be connected to intercom module (528) using conventional wireless transmission technologies to facilitate intercom communications during use of mask (10) to facilitate intercom communications with other intermediate communications modules (500), advanced communications modules (700) and handheld communications modules (900) as set forth below. External headphones (536) may be connected to standard 3.5 mm headphone jack (518) using conventional wire transmission technologies to facilitate intercom broadcast privacy by broadcasting intercom transmissions to externally connected headphones (536).

### Advanced Communications Module (700)

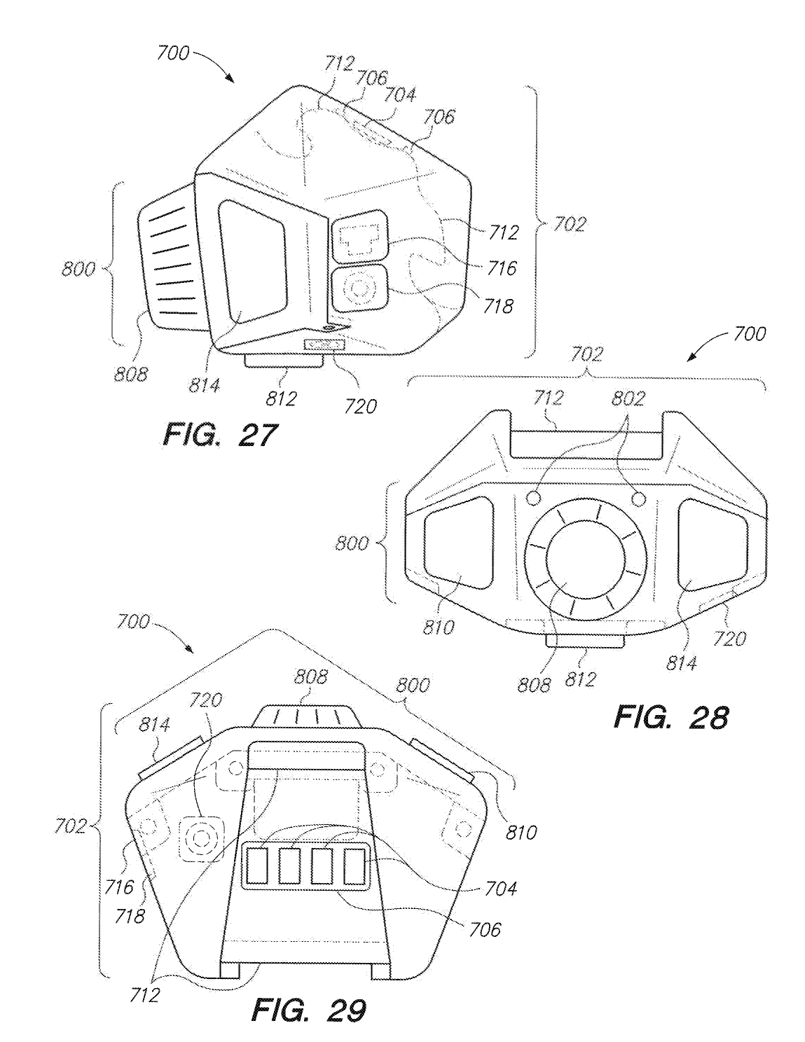

FIGS. 27-32 depict advanced communications module (700). Advanced communications module (700) comprises advanced communications module main body (702) having replaceable advanced selection panel (800) (FIGS. 27, 28), which facilitates access to a plurality of functional options during use of mask (10). Advanced communications module main body (702) comprises a plurality of electrical contacts (704) (FIGS. 27, 29) to mate with communications module mount (114) of half-mask face protector (100) (FIGS. 3-5) or communications module mount (216) of full-mask face protector (200) (FIGS. 6-8), which facilitates transmitting advanced communications module (700) functions to mask (10) during use. Advanced communications module main body (702) further comprises rubber gasket (706) (FIGS. 27, 29, 30, 32) for communications module mount (114) of half-mask face protector (100) (FIGS. 3-5), or for communications module mount (216) of full-mask face protector (200) (FIGS. 6-8). More specifically, gasket (706) is fabricated to protect, from debris and moisture, electrical connections between advanced communications module (700) and communications module mount (114) of half-mask face protector (100), and electrical connections between advanced communications module (700) and communications module mount (216) of full-mask face protector (200).

Advanced communications module main body (702) further comprises a plurality of electrical contacts (708) (FIGS. 30, 31) to mate with replaceable advanced selection panel (800), which allows replaceable advanced selection panel (800) functional options to be transmitted to advanced communications module main body (702) during use of mask (10). Advanced communications module main body (702) further comprises rubber gasket (710) (FIGS. 30, 31) for sealing with replaceable advanced selection panel (800) to protect, from debris and moisture, electrical connections between advanced communications module main body (702) and replaceable advanced selection panel (800). Advanced communications module main body (702) further comprises female section holding latch (712) to mate with and hold advanced communications module (700) in place against communications module mount (114) of half-mask face protector (100) (FIGS. 3-5) or communications module mount (216) of full-mask face protector (200) (FIGS. 6-8). Advanced communications module main body (702) is fabricated having USB jack (716) (FIGS. 27, 29, 30, 32) to facilitate battery charging and firmware updates. The USB jack (716) is protected by a rubber or plastic flap or plug to protect it from harsh environments when mask (10) is in use. Advanced communications module main body is fabricated having a standard 3.5 mm headphone jack (718) (FIGS. 27, 29, 30, 32) to facilitate privacy by broadcasting intercom transmissions and external media transmissions through externally connected headphones. The standard 3.5 mm headphone jack (718) is protected by a rubber or plastic flap or plug to protect it from harsh environments when mask (10) is in use. Advanced communications module main body is fabricated having a standard 3.5 mm auxiliary jack (720) (FIGS. 27, 29, 30, 32) to facilitate a wired connection to external media devices. The standard 3.5 mm auxiliary jack (720) is protected by a rubber or plastic flap or plug to protect it from harsh environments when mask (10) is in use.

FIGS. 27-29 and FIGS. 33-35 depict replaceable advanced selection panel (800), which allows mask (10) users to select various functions available from advanced communication module (700) during use of mask (10). Advanced selection panel (800), comprises a plurality of indicator light-emitting diode devices (802) (FIGS. 28, 34) to display mask (10) status, and a plurality of electrical contacts (804) (FIG. 35) to allow replaceable advanced selection panel (800) options to be transmitted to advanced communications module main body (702) during use of mask (10). Replaceable advanced selection panel (800) further comprises a plurality of male tabs (806a) and plurality of screw-hole male tabs (806b) and securing screws (806c) (FIGS. 33-35) to mate with female tab-spaces (722) (FIGS. 30-32) to stabilize replaceable advanced selection panel (800) in relation to advanced communications module main body (702). Replaceable advanced selection panel (800) further comprises jog dial (808) to access a plurality of functionality options, comprising volume, squelch sensitivity, noise reduction levels and similar adjustable functions. Speaker button (810) (FIGS. 28, 29, 34, 35) located on replaceable advanced selection panel (800) facilitates speaker activation when advanced communications module (700) is in use. Replaceable advanced selection panel (800) further comprises intercom button (812) (FIGS. 27, 28, 33, 34), which facilitates intercom activation when mask (10) is in use, and media button (814) (FIGS. 27.29, 33-35) to facilitate activation of external media devices in conjunction with mask (10).

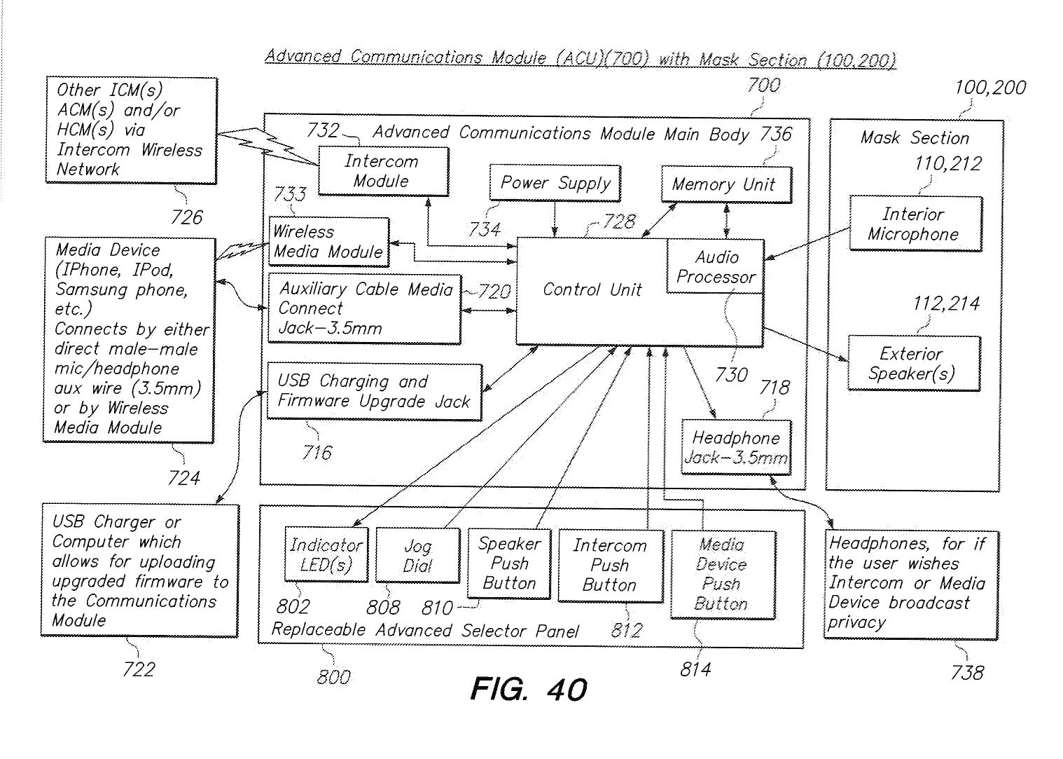

As diagrammed in FIG. 40, advanced communications module (700) further comprises intercom module (732), power supply (734), memory unit (736) and control unit (728) having an internally disposed audio processor (730). An external USB charger (722) may be connected to the USB jack (716) using conventional wire technologies to facilitate charging of the internal power supply (734) of the advanced communications module (700). Alternatively, a computer system (722) may be connected to USB jack (716) using conventional wire technologies to facilitate transmitting firmware upgrades to control unit (728) or audio processor (730) as well as charging of the internal power supply (734) of the advanced communications module (700). The intercom module of another similar device user's unit (726) may be connected to intercom module (528) using conventional wireless transmission technologies to facilitate intercom communications during use of mask (10) to facilitate intercom communications with other intermediate communications modules (500), advanced communications modules (700) and handheld communications modules (900) as set forth below. An external media unit (724) may be connected to standard 3.5 mm auxiliary jack (720) using conventional wire or may be connected to wireless media module (733) using conventional wireless transmissions technologies. External headphones (932) may be connected to standard 3.5 mm headphone jack (916) using conventional wire transmission technologies to facilitate intercom and media broadcast privacy by broadcasting intercom and media transmissions to externally connected headphones (932).

### Handheld Communications Module (900)

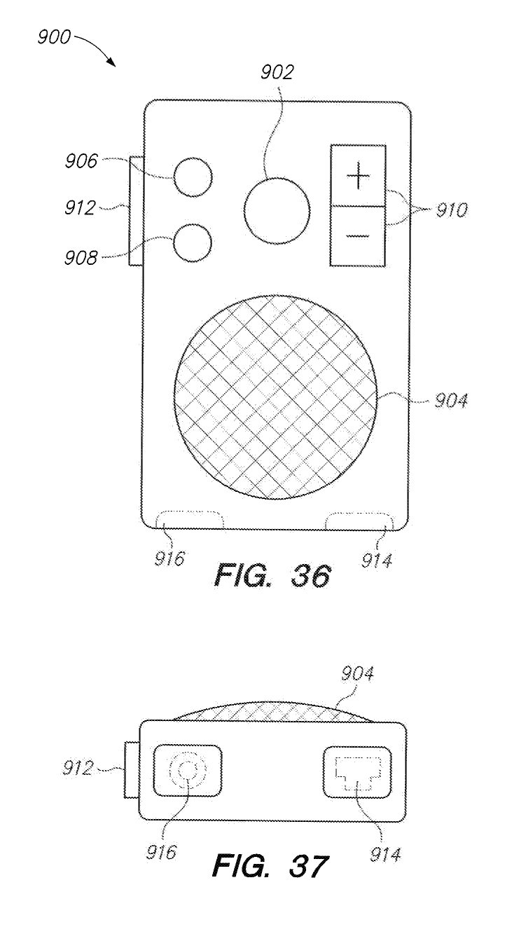

FIGS. 36-37 depict handheld communications module (900) according to the present invention. Handheld communications module (900) comprises microphone (902), which functions to record and transmit sound for intercom communications. Handheld communications module (900) further comprises at least one speaker (904) to broadcast transmitted and received intercom transmissions. Handheld communications module (900) further comprises at least one light-emitting diode device (906) to display handheld communications module (900) status during use, and power button (908) to activate and deactivate handheld communications module (900). A plurality of volume buttons (910) are disposed on handheld communications module (900) to facilitate volume control when handheld communications module (900) is in use. Handheld communications module (900) is fabricated to comprise intercom button (912) to facilitate intercom activation, USB jack (914) to facilitate battery charging and firmware updates, and standard 3.5 mm headphone jack (916) to facilitate headphone use in conjunction with handheld communications module (900). Both the USB jack (914) and the standard 3.5 mm headphone jack (916) are protected by rubber or plastic flaps or plugs to protect the jacks from harsh environments when handheld communications module (900) is in use.

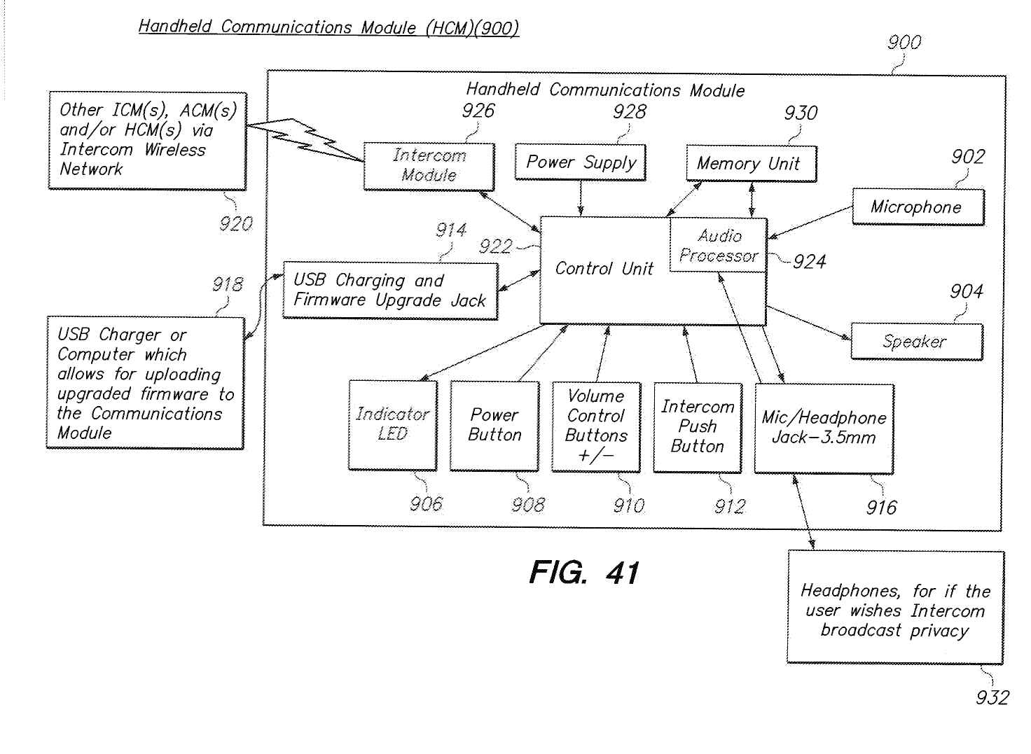

As diagrammed in FIG. 41, handheld communications module (900) further comprises intercom module (926), power supply (928), memory unit (930), and control unit (922) having an internally disposed audio processor (924). An external USB charger (918) may be connected to the USB jack (914) using conventional wire technologies to facilitate charging of the internal power supply (928) of the handheld communications module (900). Alternatively, a computer system (918) may be connected to USB jack (914) using conventional wire technologies to facilitate transmitting firmware upgrades to control unit (922) or audio processor (924) as well as charging of the internal power supply (928) of the handheld communications module (900). The intercom module of another similar device user(s)'s unit (920) may be connected to intercom module (926) using conventional wireless transmission technologies to facilitate intercom communications during use of handheld communications module (900) to facilitate intercom communications with other intermediate communications nodules (500), advanced communications modules (700) and handheld communications modules (900) as set forth below. External headphones (932) may be connected to headphone jack (916) using conventional wire transmission technologies to facilitate intercom broadcast privacy.

In operation, mask (10) allows users to choose the level and extent of functionality based on individual preference or workplace requirements. For instance, individuals may prefer, or workplace conditions may require, use of half-mask face protector (100) in conjunction with either basic communications module (300), intermediate communications module (500), or advanced communications module (700). Alternatively, individuals may prefer, or workplace conditions may require, use of full-mask face protector (200) in conjunction with either basic communications module (300), intermediate communications module (500), or advanced communications module (700). Communications module mount (114) of half-mask face protector (100) and communications module mount (216) of full-mask face protector (200) are fabricated to mount securely either of the three inventive communications modules according to the present invention. Thus, basic communications module (300), intermediate communications module (500) or advanced communications module (700) may be used in conjunction with half-mask face protector (100) or full-mask face protector (200), depending on individual preference or workplace requirements.

Each of the inventive communications modules comprise a replaceable selection panel, which houses multiple functional components that a user may access during use of mask (10). Because users are likely to contact the replaceable selection panel frequently during use of mask (10) (i.e., to activate power, control volume, adjust squelch sensitivity or activate a speaker, etc.), the replaceable selection panel may become soiled or damaged in harsh conditions. The ability to replace a damaged selection panel with a new replaceable selection panel obviates the need to purchase an entirely new mask (10) unit if the initial selection panel falls into disrepair, which extends the functional life of mask (10) and provides cost savings to mask (10) users.

Individuals who are not wearing mask (10) may wish to communicate with other individuals who are wearing mask (10). In such a scenario, handheld communications module (900) may be used by individuals who are not wearing mask (10) in order to communicate with mask (10) users.

### Basic Communications Module (300)

Basic communications module (300) allows an operator to use interior microphone (110) and exterior speaker(s) (112) of half-mask face protector (100), or interior microphone (212) and exterior speaker(s) (214) of full-mask face protector (200), to facilitate short distance communications. In operation, basic communications module (300) is mounted to either half-mask face protector (100) via communications module mount (114), or mounted to full-mask face protector (200) via communications module mount (216).

During use of mask (10), a plurality of indicator light-emitting diode devices (402), which are positioned on replaceable basic selection panel (400), indicate the status of basic communications module (300) functionality. More specifically, light-emitting diode devices (402) indicate basic communications module (300) status by displaying different colors, each color corresponding to the functional state of basic communications module (300). For instance, plurality of light-emitting diode devices (402) function as follows to display status indicator colors: glow blue when basic communications module (300) power is on; slowly blink blue when basic communications module (300) is in use; rapidly blink blue when basic communications module (300) is in wireless handshaking mode; blink red when basic communications module (300) is charging; glow red when basic communications module (300) is fully charged but the power charger is still attached; and blink alternating red and blue when basic communications module (300) encounters an error (i.e., if half-mask face protector (100) or full-mask face protector (200) is not properly connected to basic communications module (300), etc.). Light-emitting diode devices (402) glow is off when basic communications module (300) power is off.

During use of mask (10), an operator can adjust various functions of basic communications module (300) by accessing jog dial (408) on replaceable basic selection panel (400). Jog dial (408) is fabricated to combine jog and push button activation to adjust various functional options through replaceable basic selection panel (400). For instance: holding jog dial (408) inward for approximately 3 seconds turns basic communications module (300) on or off; pressing jog dial (408) once rapidly alternates jog dial (408) control between volume level mode and squelch sensitivity level mode; turning jog dial (408) when in squelch sensitivity level mode increases or decreases squelch sensitivity (i.e., microphone cut-off sensitivity levels); and pressing jog dial (408) twice in rapid succession broadcasts the power supply (i.e., battery) level from exterior speaker(s) (112) of half-mask face protector (100), or exterior speaker(s) (214) of full-mask face protector (200), depending on which face protector is selected for use. The default state of jog dial (408) is set to adjust speaker volume levels, so that turning jog dial (408) when in default mode increases or decreases speaker volume levels.

During use of mask (10), an operator can control mask (10) microphones and speakers by pressing speaker button (410) on replaceable basic selection panel (400). For instance, pressing speaker button (410) on replaceable basic selection panel (400) turns on or off exterior speaker(s) 112) of half-mask face protector (100), or exterior speaker(s) (214) of full-mask face protector (200), depending on which face protector is selected for use. In this mode, interior microphone (110) of half-face protector (100), or interior microphone (212) of full-mask face protector (200), is activated and the corresponding signal goes through audio processor (320) of control unit (318) to squelch and clarify an operator's muffled or otherwise distorted voice, and to broadcast the operator's clarified voice from exterior speaker(s) (112) of half-mask face protector (100), or exterior speaker(s) (214) of full-mask face protector (200), depending on which face protector is selected for use.

Basic communications module (300) may be connected to a conventional USB power source to charge a power supply (322) battery, or may be connected to a computer to charge a power supply (322) battery or upload firmware updates to control unit (318) and corresponding audio processor (320). For instance, upgraded control unit (318) firmware may comprise upgraded programming to facilitate bug fixes and additional functionality. Upgraded audio processor (320) firmware may comprise upgraded programming for bug fixes to squelch, background noise filtering, and clarification of an operator's muffled or otherwise distorted voice.

### Intermediate Communications Module (500)

Intermediate communications module (500) allows an operator to use interior microphone (110) and external speaker(s) (112) of half-mask face protector (100), or interior microphone (212) and exterior speaker(s) (214) of full-mask face protector (200), to facilitate short distance communications, as well as intercom communications at a longer distance between other users of intermediate communications modules (500), advanced communications modules (700), and handheld communications modules (900). Such communications may occur between operators in separate rooms or separate floors of a location, and under similar conditions where operators are out of the line-of-site of other operators. In operation, intermediate communications module (500) is mounted to either half-mask face protector (100) using communications module mount (114), or mounted to full-mask face protector (200) using communications module mount (216).

During use of mask (10), a plurality of indicator light-emitting diode devices (602), which are positioned on replaceable intermediate selection panel (600), indicate the status of intermediate communications module (500) functionality. More specifically, light-emitting diode devices (602) indicate intermediate communications module (500) status by displaying different colors, each color corresponding to the functional state of intermediate communications module (500). For instance, plurality of light-emitting diode devices (602) function as follows to display status indicator colors: glow blue when intermediate communications module (600) power is on; slowly blink blue when intermediate communications module (500) is in use; rapidly blink blue when intermediate communications module (500) is in wireless handshaking mode; blink red when intermediate communications module (500) is charging; glow red when intermediate communications module (500) is fully charged but the power charger is still attached; and blink alternating red and blue when intermediate communications module (500) encounters an error (i.e., if half-mask face protector (100) or full-mask face protector (200) is not properly connected to intermediate communications module (500), etc.). Light-emitting diode devices (602) glow is off when intermediate communications module (500) power is off.

During use of mask (10), an operator can adjust various functions of intermediate communications module (500) by accessing jog dial (610) on replaceable intermediate selection panel (600). Jog dial (610) is fabricated to combine jog and push button activation to adjust various functional options through replaceable intermediate selection panel (600). For instance: holding jog dial (610) inward for approximately 3 seconds turns intermediate communications module (500) on or off; pressing jog dial (610) once rapidly alternates jog dial (610) control between volume level mode and squelch sensitivity level mode; turning jog dial (610) when in squelch sensitivity level mode increases or decreases squelch sensitivity (i.e., microphone cut-off sensitivity levels); and pressing jog dial (610) twice in rapid succession broadcasts the power supply (i.e., battery) level from exterior speaker(s) (112) of half-mask face protector (100) or exterior speaker(s) (214) of full-mask face protector (200), depending on which face protector is selected for use. The default state of jog dial (610) is set to adjust speaker volume levels, so that turning jog dial (610) while in default mode increases or decreases speaker volume levels.

During use of mask (10), an operator can control mask (10) microphones and speakers by pressing speaker button (612) on replaceable intermediate selection panel (600). For instance, pressing speaker button (612) on replaceable intermediate selection panel (600) turns on or off exterior speaker(s) (112) of half-mask face protector (100), or exterior speaker(s) (214) of full-mask face protector (200), depending on which face protector is selected for use. In this mode, interior microphone (110) of half-face protector (100), or interior microphone (212) of full-mask face protector (200), is activated and the corresponding signal goes through audio processor (526) of control unit (524) to squelch and clarify an operator's muffled or otherwise distorted voice, and to broadcast the operator's clarified voice from exterior speaker(s) (112) of half-mask face protector (100), or exterior speaker(s) (214) of full-mask face protector (200), depending on which face protector is selected for use.

Intermediate communications module (500) is fabricated to operate using intercom wireless network communications. For a secure intercom wireless network unestablished intermediate communications module (500), holding intercom button (614) on replaceable intermediate selection panel (600) for approximately 3 seconds activates wireless handshaking to establish a secure connection with another unestablished intermediate communications module (500), advanced communications module (700) or handheld communications module (900), which is also in handshaking mode. Two unestablished intermediate communications modules (500), advanced communications modules (700) or handheld communications modules (900), will agree on a security code to establish their own secure intercom wireless network connection. One established intermediate communications module (500), advanced communications module (700), or handheld communications module (900), will connect with an unestablished intermediate communications module (500), advanced communications module (700), or handheld communications module (900), to inform it of the established secure intercom wireless network connection's security code. In this way, two established intermediate communications modules (500), advanced communications modules (700), or handheld communications modules (900), can expand the secure intercom wireless network to include additional intermediate communications modules (500), advanced communications modules (700), and handheld communications modules (900).

For a secure intercom wireless network established intermediate communications module (500), pressing (once quickly) an established intermediate communications module's intercom button (614), located on replaceable intermediate selection panel (600), sends a call out to all intermediate communications modules (500), advanced communications modules (700), and handheld communications modules (900), in range that are using a similar security code to connect with as part of the secure intercom wireless network. Pressing intercom button (614) again (once quickly) will disconnect that one intermediate communications module (500), advanced communications module (700) or handheld communications module (900), from the currently connected secure intercom wireless network. Depending on which face protector is selected for use, interior microphone (110) of half-mask face protector (100), or interior microphone (212) of full-mask face protector (200), is activated and the signal goes through audio processor (526) to squelch and clarify an operator's muffled or otherwise distorted voice, and to broadcast the operator's clarified voice to the other intermediate communications modules (500), advanced communications modules (700), and handheld communications modules (900), on the secure intercom wireless network.

If headphones are not connected to headphone jack (518) of intermediate communications module main body (502), transmissions from other intermediate communications modules (500), advanced communications modules (700), and handheld communications modules (900), on the same secure intercom wireless network, are broadcast from exterior speaker(s) (112) of half-mask face protector (100), or exterior speaker(s) (214) of full-mask face protector (200), depending on which face protector is selected for use. Alternatively, if headphones are connected to headphone jack (718) of advanced communications module main body (702), transmissions from other intermediate communications modules (500), advanced communications modules (700), and handheld communications modules (900), on the secure intercom wireless network, are broadcast from corresponding headphones connected to headphone jacks (518), (718) or (916), respectively, depending on which communications modules are in use.

Holding (for approximately 6 seconds) intercom button (614) of replaceable intermediate selection panel (600) deletes the secure intercom wireless network security code from memory unit (532) of intermediate communications module (500), so that intermediate communications module (500) is free to connect with a new secure intercom wireless network.

Intermediate communications module (500) may be connected to a conventional USB power source to charge a power supply (530) battery, or may be connected to a computer to charge a power supply (530) battery, or upload firmware updates to control unit (524) and corresponding audio processor (526). For instance, upgraded control unit (524) firmware may comprise upgraded programming to facilitate bug fixes and additional functionality. Upgraded audio processor (526) firmware may comprise upgraded programming for bug fixes to squelch, background noise filtering, and clarification of an operator's muffled or otherwise distorted voice.

### Advanced Communications Module (700)

Advanced communications module (700) allows an operator to use interior microphone (110) and external speaker(s) (112) of half-mask face protector (100), or interior microphone (212) and exterior speaker(s) (214) of full-mask face protector (200), to facilitate short distance communications, and a wireless transmitter/receiver as an intercom to facilitate communications at a longer distance between other users of intermediate communications module (500), advanced communications module (700), or handheld communications module (900) (such as between users who are in separate rooms, on different floors, or otherwise out of the line-of-sight of other operators in a location). Advanced communications module (700) also provides operators the ability to connect (either with wireless media connection module (733) connection or direct 3.5 mm conventional auxiliary wire) with media devices (724), allowing operators to listen to music, access information, place and receive phone calls, and otherwise utilize the functional capabilities of media device (724) during use of mask (10). In operation, advanced communications module (700) is mounted to either half-mask face protector (100) using communications module mount (114), or mounted to full-mask face protector (200) using communications module mount (216).

During use of mask (10), a plurality of indicator light-emitting diode devices (802), which are positioned on replaceable advanced selection panel (800), indicate the status of advanced communications module (700) functionality. More specifically, light-emitting diode devices (802) indicate advanced communications module (700) status by displaying different colors, each color corresponding to the functional state of advanced communications module (700). For instance, plurality of light-emitting diode devices (802) function as follows to display status indicator colors: glow blue when advanced communications module (700) power is on; slowly blink blue when advanced communications module (700) is in use; rapidly blink blue when advanced communications module (700) is in wireless handshaking mode; blink red when advanced communications module (700) is charging; glow red when advanced communications module (700) is fully charged but the power charger is still attached; and blink alternating red and blue when advanced communications module (700) encounters an error (i.e., if half-mask face protector (100) or full-mask face protector (200) is not properly connected to advanced communications module (700), etc.). Light-emitting diode devices (802) glow is off when advanced communications module (700) power is off.

During use of mask (10), an operator can adjust various functions of advanced communications module (700) by accessing jog dial (808) on replaceable advanced selection panel (800). Jog dial (808) is fabricated to combine jog and push button activation to adjust various functional options through replaceable advanced selection panel (800). For instance: holding jog dial (808) inward for approximately 3 seconds turns advanced communications module (700) on or off; pressing jog dial (808) once rapidly alternates jog dial (808) control between volume level mode and squelch sensitivity level mode; turning jog dial (808) when in squelch sensitivity level mode increases or decreases squelch sensitivity (i.e., microphone cut-off sensitivity levels); and pressing jog dial (808) twice in rapid succession broadcasts the power supply (i.e., battery) level from exterior speaker(s) (112) of half-mask face protector (100), or exterior speaker(s) (214) of full-mask face protector (200), depending on which face protector is selected for use. The default state of jog dial (808) is set to adjust speaker volume levels, so that turning jog dial (808) while in default mode increases or decreases speaker volume levels.

During use of mask (10), an operator can control mask (10) microphones and speakers by pressing speaker button (810) on replaceable advanced selection panel (800). For instance, pressing speaker button (810) on replaceable advanced selection panel (800) turns on or off exterior speaker(s) (112) of half-mask face protector (100), or exterior speaker(s) (214) of full-mask face protector (200), depending on which face protector is selected for use. In this mode, interior microphone (110) of half-face protector (100), or interior microphone (212) of full-mask face protector (200), is activated and the corresponding signal goes through audio processor (730) of control unit (728) to squelch and clarify an operator's muffled or otherwise distorted voice, and to broadcast the operator's clarified voice from exterior speaker(s) (112) of half-mask face protector (100), or exterior speaker(s) (214) of full-mask face protector (200), depending on which face protector is selected for use.

Advanced communications module (700) is also fabricated to operate using intercom wireless network communications. For a secure intercom wireless network unestablished advanced communications module (700), holding intercom button (812) on replaceable advanced selection panel (800) for approximately 3 seconds activates wireless handshaking to establish a secure connection with another unestablished intermediate communications module (500), advanced communications module (700), or handheld communications module (900), which are also in handshaking mode. Two unestablished intermediate communications modules (500), advanced communications modules (700), or handheld communications modules (900) will agree on a security code to establish their own secure intercom wireless network connection. One established intermediate communications module (500), advanced communications module (700), or handheld communications module (900), will connect with an unestablished intermediate communications module (500), advanced communications module (700), or handheld communications module (900), to inform it of the established secure intercom wireless network connection's security code. In this way, two established intermediate communications modules (500), advanced communications modules (700), or handheld communications modules (900), can expand the secure intercom wireless network to include additional intermediate communications modules (500), advanced communications modules (700), and handheld communications modules (900).

For a secure intercom wireless network established advanced communications module (700), pressing (once quickly) an established advanced communications module's intercom button (812), located on replaceable advanced selection panel (800), sends a call out to all intermediate communications modules (500), advanced communications modules (700), and handheld communications modules (900), in range that are using a similar security code to connect with as part of the secure intercom wireless network. Pressing intercom button (812) again (once quickly) will disconnect that one intermediate communications module (500), advanced communications module (700), or handheld communications module (900), from the currently connected secure intercom wireless network. Depending on which face protector is selected for use, interior microphone (110) of half-mask face protector (100), or interior microphone (212) of full-mask face protector (200), is activated and the signal goes through audio processor (730) to squelch and clarify an operator's muffled or otherwise distorted voice, and to broadcast the operator's clarified voice to other intermediate communications modules (500), advanced communications modules (700), and handheld communications modules (900), on the secure intercom wireless network.

If headphones are not connected to headphone jack (718) of advanced communications module main body (702), transmissions from other intermediate communications modules (500), advanced communications modules (700), and handheld communications modules (900), on the same secure intercom wireless network, are broadcast from exterior speaker(s) (112) of half-mask face protector (100), or exterior speaker(s) (214) of full-mask face protector (200), depending on which face protector is selected for use. Alternatively, if headphones are connected to headphone jack (718) of advanced communications module main body (702), transmissions from other intermediate communications modules (500), advanced communications modules (700), and handheld communications modules (900), on the secure intercom wireless network, are broadcast from corresponding headphones connected to headphone jacks (518), (718) or (916), respectively, depending which communications modules are in use.

Holding (for approximately 6 seconds) intercom button (812) of replaceable advanced selection panel (800) deletes the secure intercom wireless network security code from memory unit (736) of advanced communications module (700), so that advanced communications module (700) is free to connect with a new secure intercom wireless network.

For an advanced communications module (700) connected to media device (724) with a 3.5 mm conventional auxiliary wire, wireless media connection module (733) need not be activated. For an advanced communications module (700) with a direct connection to media device (724), holding media button (814) for approximately 2 seconds turns on or off the direct connection to media device (724). Quickly pressing media button (814) activates voice recognition capabilities in smart phones, smart listening devices, smart tablets, and other similar smart electronic devices comprising media device (724), to facilitate making phone calls, listening to music, and otherwise activating media device (724) functionality.

Depending on which face protector is selected for use, interior microphone (110) of half-mask face protector (100), or interior microphone (212) of full-mask face protector (200), is activated and the signal goes through audio processor (730) to squelch and clarify an operator's muffled or otherwise distorted voice to media device (724). If headphones are not connected to headphone jack (718) of advanced communications module main body (702), then transmissions from media device (724) are broadcast from exterior speaker(s) (112) of half-mask face protector (100), or exterior speaker(s) (214) of full-mask face protector (200), depending on which face protector is selected for use. Alternatively, if headphones are connected to headphone jack (718) of advanced communication module main body (702), then media device (724) headphone broadcast is sent to the separate headphones. While the direct connection to media device (724) is on, phone calls made to media device (724) will ring advanced communications module (700), and pressing media button (814) of replaceable advanced selection panel (800) will answer the phone call. Pressing media button (814) again quickly will disconnect the phone call.

For an advanced communications module (700) without a wireless media connection module (733) connection to a media device (724) established, holding media button (814) for approximately 4 seconds activates advanced communications module (700) wireless media connection module (733) handshaking to establish and memorize a secure connection with wireless media connection module (733) enabled media device (724). For an advanced communications module (700) with a wireless media connection module (733) connection to media device (724) memorized, holding media button (814) for approximately 2 seconds turns on or off the wireless media connection module (733) connection to media device (724). Quickly pressing media button (814) activates media device (724) voice recognition capabilities, to facilitate placing phone calls, listening to music, or otherwise accessing media device (724) capabilities. Depending on which face mask is selected for use, interior microphone (110) of half-mask face protector (100), or interior microphone (212) of full-mask face protector (200), is activated and the signal goes through audio processor (730) to squelch and clarify an operator's muffled or otherwise distorted voice to media device (724). If headphones are not connected to headphone jack (718) of advanced communications module main body (702), then transmissions from media device (724) are broadcast from exterior speaker(s) (112) of half-mask face protector (100), or exterior speaker(s) (214) of full-mask face protector (200), depending on which face protector is selected for use. Alternatively, if headphones are connected to headphone jack (718) of advanced communications module main body (702), then the media device (724) headphones broadcast is sent to the separate headphones.

While the wireless media connection module (733) connection to media device (724) is on, phone calls made to media device (724) will ring advanced communications module (700), and pressing media button (814) will answer the phone call. Pressing media button (814) again will disconnect the phone call. Holding media button (814) for approximately 6 seconds deletes the secure connection between media device (724) and wireless media connection module (733), so that advanced communications module (700) is free to connect with another media device (724).

If a 3.5 mm auxiliary wire is connected to the auxiliary jack (720), the control unit (728) will default to connecting with the media device (724) using the 3.5 mm auxiliary wire connection rather than the wireless media connection module (733).

Advanced communications module (700) may be connected to a conventional USB power source to charge a power supply (734) battery, or may be connected to a computer to charge a power supply (734) battery or upload firmware updates to control unit (728) and corresponding audio processor (730). For instance, upgraded control unit (728) firmware may comprise upgraded programming to facilitate bug fixes and additional functionality. Upgraded audio processor (730) firmware may comprise upgraded programming for bug fixes to squelch, background noise filtering, and clarification of an operator's muffled or otherwise distorted voice.

### Handheld Communications Module (900)

Handheld communications module (900) allows an operator to use built-in microphone (902), speaker (904) (or a conventional headset microphone and headphones), and a wireless transmitter/receiver as an intercom to facilitate communications at a relatively longer distance (as compared to basic communications module (300)) between other users of intermediate communications modules (500), advanced communications modules (700), and handheld communications modules (900). Such communications may occur between operators in separate rooms or on separate floors of a location, and under similar conditions where operators are out of the line-of-site of other operators.

During use of handheld communications module (900), a plurality of indicator light-emitting diode devices (906), which are positioned on handheld communications module (900), indicate the status of handheld communications module (900) functionality. More specifically, light-emitting diode devices (906) indicate handheld communications module (900) status displaying different colors, each color corresponding to the functional state of handheld communications module (900). For instance, plurality of light-emitting diode devices (906) function as follows to display status indicator colors: glow blue when handheld communications module (900) power is on; slowly blink blue when handheld communications module (900) is in use; rapidly blink blue when handheld communications module (900) is in wireless handshaking mode; blink red when handheld communications module (900) is charging; glow red when handheld communications module (900) is fully charged but the power charger is still attached; and blink alternating red and blue when handheld communications module (900) encounters an error, such as if intercom button (912) is pressed to connect with a wireless network without having been first established as part of a wireless network.

Pressing power button (908) turns handheld communication module (900) on and off. Pressing volume buttons (910) adjust up or down the volume of built-in speaker (904), or conventional headphones that are connected to headphone jack (916). For a secure intercom wireless network unestablished handheld communications module (900), holding intercom button (912) for approximately 3 seconds activates wireless handshaking to establish a secure connection with another unestablished intermediate communications module (500), advanced communications module (700), or handheld communications module (900), which is concurrently in handshaking mode as well. Two unestablished intermediate communications modules (500), advanced communications modules (700), or handheld communications modules (900), will agree on a security code to establish their own new intercom wireless connection. One established intermediate communications module (500), advanced communications module (700), or handheld communications module (900) will connect with an unestablished intermediate communications module (500), advanced communications module (700), or handheld communications module (900) to inform it of the established intercom wireless network connection's security code. In this way, two established intermediate communications modules (500), advanced communications modules (700), or handheld communications modules (900), can expand the secure intercom wireless network to additional users of intermediate communications modules (500), advanced communications modules (700), and handheld communications modules (900).

For a secure intercom wireless network established handheld communications module (900), pressing an established handheld communications module (900) intercom button (912) once quickly send a call out to other intermediate communications modules (500), advanced communications modules (700), and handheld communications modules (900), in range that are using a similar security code to connect with as part of the intercom wireless network. Pressing intercom button (912) again once quickly will disconnect that one intermediate communications module (500), advanced communications module (700), and handheld communications module (900) from the concurrently connected intercom wireless network. If neither microphones nor headphones are connected to headphone jack (916), built-in microphone (902) is activated and the signal goes through audio processor (924) to clarify the operator's voice and broadcast the operator's voice to other intermediate communications modules (500), advanced communications modules (700), and handheld communications modules (900) on the secure intercom wireless network.

Alternatively, if a microphone and headphones are connected to headphone jack (916), then the microphone corresponding to the headphones is activated and the signal goes through audio processor (924) to clarify an operator's voice and broadcast the operator's voice to the other intermediate communications modules (500), advanced communications modules (700), and handheld communications modules (900), on the secure intercom wireless network. If a microphone and headphones are not connected to headphone jack (916), then transmissions from other intermediate communications modules (500), advanced communications modules (700), and handheld communications modules (900), on the secure intercom wireless network are broadcast from built-in speaker (904). If a microphone and headphones are connected to headphone jack (916), then transmissions from other advanced communications modules (700) on the intercom wireless network are broadcast from the headphones. Holding intercom button (912) for approximately 6 seconds deletes the secure intercom wireless network code from memory unit (930) of handheld communications module (900), so that handheld communications module (900) is free to connect with another intercom wireless network.

Handheld communications module (900) may be connected to a conventional USB power source to charge a power supply (928) battery, or may be connected to a computer to charge a power supply (928) battery or upload firmware updates to control unit (922) and corresponding audio processor (924). For instance, upgraded control unit (922) firmware may comprise upgraded programming to facilitate bug fixes and additional functionality. Upgraded audio processor (924) firmware may comprise upgraded programming for bug fixes to squelch, background noise filtering, and clarification of an operator's muffled or otherwise distorted voice.

The foregoing is considered illustrative only of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. Various other objects, advantages and features of the present invention will become readily apparent to those of ordinary skill in the art. While the invention has been described with reference to at least one preferred embodiment, it is to be understood by those skilled in the art that the invention is not limited thereto. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The invention is defined by the following claims, with equivalents of the claims to be included therein.

What is claimed is:

1. A communication enhanced protective mask to facilitate workplace communication comprising:
(A) A face protector comprising a communication mount to facilitate user communication, a plurality of straps to help secure said mask to a user's face, a plurality of ventilation ports to facilitate respiration with air filtration, and an outer surface and an inner surface to provide a barrier between a mask user's face and airborne workplace contaminants, wherein said inner surface is configured to define a clean air compartment between said inner surface and the user's face to provide filtered, breathable air during use of said mask;
(B) A communication module removeably attached to said communication mount of said face protector to facilitate communicate between other similar mask users and non-mask users without removing said mask from the user's face; and
(C) A selection panel removeably attached to said communication module to facilitate a user's control of said communication module functionality during use of said mask without removing said mask from a user's face.

2. A mask according to claim 1 wherein said face protector comprises a half-mask face protector having an interior microphone to receive the user's voice, and a plurality of external speakers to broadcast communications.

3. A mask according to claim 1 wherein said face protector comprises a full-mask face protector having an interior microphone to receive the user's voice, and a plurality of external speakers to broadcast communications.

4. A mask according to claim 1 wherein said communication mount comprises a plurality of electrical contacts to facilitate microphone and speaker functionality of said communication module, a rubber bumper to help stabilize said communication module during use of said mask, and a holding latch to help stabilize said communication module in connection to said communication mount.

5. The mask according to claim 1 further comprising a communication module having a main body and a removeably connected selection panel, wherein said main body comprises a plurality of electrical contacts to connect to said communication mount of said face protector to facilitate information transmission to said communication module main body, a USB jack, and a plurality of electrical contacts to connect to said selection panel; and wherein said selection panel comprises a plurality of LED indicator lights to display device status, a plurality of electrical contacts to facilitate information communication to said communication module main body, a jog dial to facilitate controlling communication module power, volume, squelch and multiple other device functions, and a speaker button to facilitate speaker activation.

6. A mask according to claim 1 further comprising a communication module having a main body and a removeably connected selection panel, wherein said main body comprises a plurality of electrical contacts to connect to said communication mount of said face protector to facilitate information transmission to said communication module main body, a USB jack, a headphone jack, and a plurality of electrical contacts to connect to said selection panel; and wherein said selection panel comprises a plurality of LED indicator lights to display device status, a plurality of electrical contacts to facilitate information communication to said communication module main body, a jog dial to facilitate controlling communication module power, volume, squelch and multiple other device functions, a speaker button to facilitate speaker activation, and an intercom button to facilitate intercom activation.

7. A mask according to claim 1 further comprising a communication module having a main body and a removeably connected selection panel, wherein said main body comprises a plurality of electrical contacts to connect to said communication mount of said face protector to facilitate information transmission to said communication module main body, a USB jack, a headphone jack, an AUX jack to facilitate connection to external media and telephone devices, and a plurality of electrical contacts to connect to said selection panel; and wherein said selection panel comprises a plurality of LED indicator lights to display device status, a plurality of electrical contacts to facilitate information communication to said communication module main body, a jog dial to facilitate controlling communication module power, volume, squelch and multiple other device functions, a speaker button to facilitate speaker activation, an intercom button to facilitate intercom activation, and a media button to facilitate external media activation.

8. A mask according to claim 1 wherein said communication module comprises, alternatively, a handheld device comprising a microphone to facilitate intercom transmission, at least one speaker to broadcast intercom transmissions, a plurality of indicator LEDs to display device status, a plurality of control buttons to facilitate control of device power, volume and intercom activation, a USB jack and a headphone jack.

9. A speech enhanced protective mask to facilitate workplace communication comprising:
(A) A face protector comprising a communication mount to facilitate user communication, a plurality of externally disposed straps to help secure said mask to a user's face, a plurality of ventilation ports to facilitate respiration with air filtration, and an outer surface and an inner surface configured to define a clean air space between said inner surface and a user's face to provide filtered, breathable air during use of said mask;
(B) A communication module removeably attached to said communication mount of said face protector to facilitate communication between mask users and non-mask users without removing said mask from the user's face, wherein said communication module comprises a main body having a plurality of electrical contacts to facilitate communication, and a USB jack to supply power to recharge batteries and allow external software access; and
(C) A selection panel removeably attached to said communication module to facilitate a user's control of said communication module functionality, wherein said selection panel comprises a plurality of LED indicator lights to display device status, a plurality of electrical contacts to facilitate information communication to said communication main body, a jog dial to facilitate controlling communication module power, volume, squelch and multiple other device functions, and a speaker button to facilitate speaker activation.

10. The mask according to claim 9 wherein said communication module main body further comprises a plurality of rubber gaskets to protect said plurality of electrical contacts from debris, moisture and other external contaminants, and a holding latch to help stabilize said communication module in relation to said communication mount.

11. A mask according to claim 9 wherein said communication module comprises, alternatively, a handheld device having a microphone to facilitate intercom transmission, at least one speaker to broadcast intercom transmissions, a plurality of indicator LEDs to display device status, a plurality of control buttons to facilitate control of device power, volume and intercom activation, a USB jack and a headphone jack.

12. A mask according to claim 9 wherein said face protector comprises a half-mask face protector having an interior microphone to receive the user's voice, and a plurality of external speakers to broadcast communications.

13. A mask according to claim 9 wherein said face protector comprises a full-mask face protector having an interior microphone to receive the user's voice, and a plurality of external speakers to broadcast communications.

14. A speech enhanced protective mask to facilitate workplace communication comprising:
(A) A face protector comprising a communication mount to facilitate user communication, a plurality of externally disposed straps to help secure said mask to a user's face, a plurality of ventilation ports to facilitate respiration with air filtration, and an outer surface and an inner surface configured to define a clean air space between said inner surface and a user's face to provide filtered, breathable air during use of said mask;
(B) A communication module removeably attached to said communication mount of said face protector to facilitate communication between mask users and non-mask users without removing said mask from the user's face, wherein said communication module comprises a main body having a plurality of electrical contacts to facilitate communication, a USB jack to supply power to recharge batteries and allow external software access, and a headphone jack; and
(C) A selection panel removeably attached to said communication module to facilitate a user's control of said communication module functionality, wherein said selection panel comprises a plurality of LED indicator lights to display device status, a plurality of electrical contacts to facilitate information communication to said communication main body, a jog dial to facilitate controlling communication module power, volume, squelch and multiple other device functions, a speaker button to facilitate speaker activation and an intercom button to control intercom activation.

15. The mask according to claim 14 wherein said communication module main body further comprises a plurality of rubber gaskets to protect said plurality of electrical contacts from debris, moisture and other external contaminants, and a holding latch to help stabilize said communication module in relation to said communication mount; and wherein said selection panel further comprises a plurality of positioning tabs and screws to stabilize said selection panel to said communication module main body.

16. A mask according to claim 14 wherein said communication module comprises, alternatively, a handheld device having a microphone to facilitate intercom transmission, at least one speaker to broadcast intercom transmissions, a plurality of indicator LEDs to display device status, a plurality of control buttons to facilitate control of device power, volume and intercom activation, a USB jack and a headphone jack.

17. A mask according to claim 14 wherein said face protector comprises a half-mask face protector having an interior microphone to receive the user's voice, and a plurality of external speakers to broadcast communications.

18. A mask according to claim 14 wherein said face protector comprises a full-mask face protector having an interior microphone to receive the user's voice, and a plurality of external speakers to broadcast communications.

19. A speech enhanced protective mask to facilitate workplace communication comprising:
(A) A face protector comprising a communication mount to facilitate user communication, a plurality of externally disposed straps to help secure said mask to a user's face, a plurality of ventilation ports to facilitate respiration with air filtration, and an outer surface and an inner surface configured to define a clean air space between said inner surface and a user's face to provide filtered, breathable air during use of said mask;
(B) A communication module removeably attached to said communication mount of said face protector to facilitate communication between mask users and non-mask users without removing said mask from the user's face, wherein said communication module comprises a main body having a plurality of electrical contacts to facilitate communication, a USB jack to supply power to recharge batteries and allow external software access, a headphone jack, and an AUX jack; and
(C) A selection panel removeably attached to said communication module to facilitate a user's control of said communication module functionality, wherein said selection panel comprises a plurality of LED indicator lights to display device status, a plurality of electrical contacts to facilitate information communication to said communication main body, a jog dial to facilitate controlling communication module power, volume, squelch and multiple other device functions, a speaker button to facilitate speaker activation, an intercom button to control intercom activation, and a media button to control media activation.

20. The mask according to claim 19 wherein said communication module main body further comprises a plurality of rubber gaskets to protect said plurality of electrical contacts from debris, moisture and other external contaminants, and a holding latch to help stabilize said communication module in relation to said communication mount; and wherein said selection panel further comprises a plurality of positioning tabs and screws to stabilize said selection panel to said communication module main body.

21. A mask according to claim 19 wherein said communication module comprises, alternatively, a handheld device having a microphone to facilitate intercom transmission, at least one speaker to broadcast intercom transmissions, a plurality of indicator LEDs to display device status, a plurality of control buttons to facilitate control of device power, volume and intercom activation, a USB jack and a headphone jack.

22. A mask according to claim 19 wherein said face protector comprises a half-mask face protector having an interior microphone to receive the user's voice, and a plurality of external speakers to broadcast communications.

23. A mask according to claim 19 wherein said face protector comprises a full-mask face protector having an interior microphone to receive the user's voice, and a plurality of external speakers to broadcast communications.
